(19) United States
(12) Patent Application Publication
(10) Pub. No.: US 2025/0142309 A1
(43) Pub. Date: May 1, 2025

(54) SYSTEMS AND METHODS FOR EMERGENCY RESPONSE PROTOCOL

(71) Applicant: RapidSOS, Inc., New York, NY (US)

(72) Inventors: Conor Fucci, Brooklyn, NY (US); Daniel Richard Seidberg, Manlius, NY (US); Michael Anthony Heneka, Fabius, NY (US); Patricia Ann Beesley, Cedar Grove, NJ (US); Lillian Nguyen, San Bruno, CA (US)

(21) Appl. No.: 18/924,080

(22) Filed: Oct. 23, 2024

Related U.S. Application Data
(60) Provisional application No. 63/546,102, filed on Oct. 27, 2023.

(51) Int. Cl. H04W 4/90; H04L 51/18; H04M 1/72424; H04M 1/72436; H04W 4/021

(52) U.S. Cl. CPC H04W 4/90; H04L 51/18; H04M 1/72424; H04M 1/72436; H04W 4/021; H04M 2201/42

(57) ABSTRACT

Systems and methods for implementing emergency response protocols and providing incident data to field responders are provided herein. In one example, a method for providing incident data to one or more field responders includes receiving notification criteria associated with a field response provider and receiving incident data regarding an incident. The method also includes determining, based on the notification criteria and the incident data, at least one target field responder to receive the incident data and transmitting the incident data to a graphical user interface executed on a computing device associated with an emergency communication center (ECC), wherein the ECC controls dispatch of field responders to incidents. The method further may include transmitting the incident data to the at least one target field responder prior to the at least one target field responder being dispatched to the incident by the ECC.

### CROSS-REFERENCE TO RELATED APPLICATIONS

This application claims the benefit of U.S. Provisional Application No. 63/546,012, filed Oct. 27, 2023, the entire contents of which are incorporated herein by reference.

### TECHNICAL FIELD

This disclosure relates generally to systems and methods for emergency response, and, more specifically, for sharing emergency information with field responders.

### BACKGROUND

Field responders depend on a flow of data communications to obtain situational awareness about an emergency incident that is critical to their response to the incident. Communicating data to field responders for high priority incidents is important for having a faster, more informed response. It may be advantageous to be able to communicate quickly and easily with field responders so that field responders are able to fully coordinate preparedness and response.

### BRIEF DESCRIPTION OF THE DRAWINGS

The above needs are at least partially met through provision of the systems and methods for emergency response protocol described in the following detailed description, particularly when studied in conjunction with the drawings, wherein:

FIG. 1 is a schematic diagram of an exemplary emergency management provider system, in accordance with some embodiments;

FIG. 2 is a flow diagram of a method for an emergency response protocol for sharing incident data with field responders, in accordance with some embodiments;

FIG. 3A is a flow diagram of a method for an emergency response protocol for sharing incident data with field responders using notification criteria, in accordance with some embodiments;

FIG. 3B is a flow diagram of a method of identifying an incident and incident data via an emergency management system, in accordance with some embodiments;

FIG. 3C is a flow diagram of another method of identifying an incident and incident data via an emergency management system, in accordance with some embodiments;

FIG. 4 is a flow diagram of a method for an emergency response protocol for transmitting incident data to an emergency responder system and field responders, in accordance with some embodiments;

FIG. 5 is a flow diagram of a method for an emergency response protocol for transmitting incident data from an emergency management system to field responders, in accordance with some embodiments;

FIG. 6 is a flow diagram of a method for an emergency response protocol for transmitting incident data to an emergency communications center and to field responders;

FIG. 7 is an exemplary user interface displaying a field responder call list, in accordance with some embodiments;

FIG. 8 is an exemplary notification screen viewed on a field responder device, in accordance with some embodiments;

FIG. 9A is an exemplary emergency communications center (ECC) user interface displaying incident data, in accordance with some embodiments;

FIG. 9B is an exemplary ECC user interface displaying data fields for entering incident data recipients, in accordance with some embodiments;

FIG. 10 is a flow diagram of a method for emergency response protocol for transmitting incident data to field responders, in accordance with some embodiments;

FIGS. 11A, 11B, and 11C illustrate parts of a flow diagram of a method for emergency response protocol for transmitting incident data to a field response provider, in accordance with some embodiments;

FIG. 12 is a flow diagram of a method for emergency response protocol for transmitting incident data via a webpage to field responders, in accordance with some embodiments;

FIG. 13 is a flow diagram of a method for emergency response protocol for accessing incident data via a webpage and reporting link access, in accordance with some embodiments;

FIG. 14 illustrates a schematic diagram of a webpage for displaying incident data to field responders, in accordance with some embodiments;

FIG. 15A is an exemplary ECC user interface displaying incident data for a plurality of incidents on a map, in accordance with some embodiments;

FIG. 15B is an exemplary ECC user interface displaying incident data for an active assailant incident on a map, in accordance with some embodiments; and

FIG. 16 is an exemplary system for use in implementing systems, apparatuses, devices, methods, techniques, and the like for emergency response protocols, in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, the systems and methods for emergency response protocol described herein provide incident data, for example as an alert or pre-alert, to field responder providers, field responders, or others associated with an incident. In various approaches, the incident data may be provided to field responders before, after, or at the same time incident data is provided to an Emergency Communication Center (ECC). In some embodiments, the systems and methods for emergency response protocols provide incident data as “pre-alerts” that are sent to field responder providers or field responders before field responders are formally dispatched to the scene by an ECC. In this manner, the systems and methods for emergency response protocol proactively provide information to field responders so that field responders can prepare for the incident response in advance of being dispatched to the scene by an ECC. Providing incident data to field responders may help to ensure field responders have the data they need to inform the units, gear, and precautions needed to appropriately respond to the incident.

It is contemplated that the approaches described herein may provide emergency response protocols that are easily scalable. The approaches described herein may also be easily integrated with various systems such as field responder systems, SMS (text or data), and/or email to efficiently provide information to and receive information from field responders to improve response times and provide incident data to prepare filed responders for potential challenges on scene.

Incidents may include any occurrences, natural or human-caused, that require a response to protect life or property. Incidents may, for example, include major disasters that are natural or human-caused, emergencies, terrorist attacks, terrorist threats, civil unrest, wildland and urban fires, floods, hazardous materials spills, nuclear accidents, aircraft accidents, earthquakes, hurricanes, tornadoes, tropical storms, tsunamis, war-related disasters, public health and medical emergencies, and other occurrences requiring an emergency response. Human-caused occurrences may include train derailments, burglaries, carbon monoxide leaks, natural gas leaks, holdups, active assailants, etc. In some cases, the emergency may be a mass casualty incident.

In some cases, incidents that occur may greatly impact infrastructure systems. Public infrastructure refers to governmentally developed, owned and operated infrastructure facilities, systems, and structures that are open to the general public for use while private infrastructure refers to any infrastructure or portion of an infrastructure not owned by or dedicated to a governmental or public entity or authority. Examples of infrastructure systems include, but are not limited to, transport infrastructure such as roads, rail, cable, and shipping ports; aviation infrastructure such as air traffic control technology; rail transport such as trackage, signals, electrification of rails; road transport such as roads, bridges, tunnels, critical infrastructure such as assets required to sustain human life; energy infrastructure such as transmission and storage of fossil fuels and renewable sources; electrical grid such as transmission and distribution stations, power lines, power plants, etc.; hazardous waste such as disposal and handling; information and communication infrastructure such as systems of information storage and distribution; solid waste such as generation, collection, management of trash, garbage and recycling; water infrastructure for the distribution and maintenance of water supply; wastewater infrastructure for disposal and treatment of wastewater, etc.

Many of these infrastructure systems may encounter emergencies that involve not only the specific infrastructure system, but interfaces between some of the various systems and multiple facets of infrastructure systems that may need to work together to resolve emergencies. In one example, transport infrastructure such as railways may be used to transport hazardous material. If a train derailment occurs for a train carrying hazardous materials, the emergency may involve hazardous material containment and management, in addition to railway issues, and the event could present dangers of toxicity to the emergency responders as well as the surrounding community where the derailment occurred. Time is of the essence in responding to such dangers. Many other dangerous situations occur for downed power lines, pipeline spills, gas leaks and other emergencies related to infrastructure systems. Each possible situation requires handling using specific knowledge related to the situation; however, unfortunately, the required information is not available to field responders in a timely manner.

Field responders (also referred to as “emergency responders”) may include volunteer and career firefighters, law enforcement, medical responders, hazardous material handling crews, Federal Emergency Management (FEMA) employees, National Guard members, or any other individuals, groups of individuals, or government agencies that engage in responding to incidents or supplying materials or manpower for incidents. Field responders, in some approaches, may be formally dispatched by an ECC. The systems and methods for emergency response protocol described herein may be used to distribute incident information or data to one or more field responders, for example, before or when the field responder is dispatched to the scene of the incident. In some approaches, the incident data may be verbally communicated to one or more field responders via phone call or radio. In other approaches, the incident data may be communicated to one or more field responders via an application user interface available to one or more first responders on their responder devices, such as laptops, mobile phones, tablets, vehicular consoles, walkie talkies, etc. In yet other approaches, the incident data may be communicated to one or more first responders via a hyperlink that is sent via SMS (text or data), email, or other messaging applications on their responder devices, as described further below. By some approaches, the incident data may be disseminated via an application programming interface (API) with the computer system of the responding agency.

As referred to herein, an emergency communication center (ECC) may be a primary agency (such as a public safety answering point (PSAP)), a secondary agency (such as a police department, fire department), a regional agency (a statewide or federal agency), etc. An ECC may have telecommunicators and/or dispatchers that triage 911 calls and dispatch field responders. Sometimes telecommunicators and dispatchers may be separate roles or may be combined into a single role.

Field response providers (also referred to as emergency service providers (ESPs) or emergency response providers) may be any entity, group, etc. that is associated with one or more field responders. In one example, a field response provider may be a field responder technology company that has user bases of field responders using the company's application and/or technology to enable better emergency response. In another example, a field response provider may be a department such as a fire department or police department or other government or volunteer department or entity.

In some aspects, a method for providing incident data to one or more field responders may include receiving notification criteria associated with a field response provider and receiving incident data regarding an incident. In some embodiments, the method further includes determining, based on the notification criteria and the incident data, at least one target field responder associated with the field response provider to receive the incident data. The method may, in illustrative approaches, further include transmitting the incident data to a graphical user interface executed on a computing device associated with an emergency communication center (ECC), wherein the ECC controls dispatch of field responders to incidents. The method may also include transmitting the incident data to the at least one target field responder. In some examples, this occurs prior to the at least one target field responder being dispatched to the incident by the ECC.

In some aspects, an emergency management system (EMS) includes at least one memory including computer program code, a network component, and at least one processor, the processor communicatively coupled to an emergency data source. In some approaches, the at least one memory and the computer program code, with the at least one processor, are configured to cause the EMS to: receive an emergency alert comprising a location of an emergency and determine, using the location of the emergency, an appropriate emergency communication center (ECC) for responding to the emergency, wherein the ECC controls dispatch of field responders to incidents. In some approaches, the EMS is also caused to receive a list of contact information associated with a plurality of responders associated with an emergency service provider (ESP), wherein the ESP has authorized sharing of the emergency alert with the plurality of responders; and transmit to a plurality of responder devices associated with the plurality of responders, a notification message including the location of the emergency.

In yet other aspects, a method for executing an incident response management protocol may include receiving, at a server computing device, incident information associated with an incident and determining at least one set of field responders to receive the incident information, based on notification criteria associated with the field responders and the incident information. In some approaches, the method also includes transmitting, from the server computing device to user devices associated with the set of field responders, the incident information. In some examples, the method includes transmitting, from the server computing device to an emergency communication center (ECC) server. In some approaches, the transmitting to the ECC server of the incident information is concurrent with the transmission of information to the set of field responders.

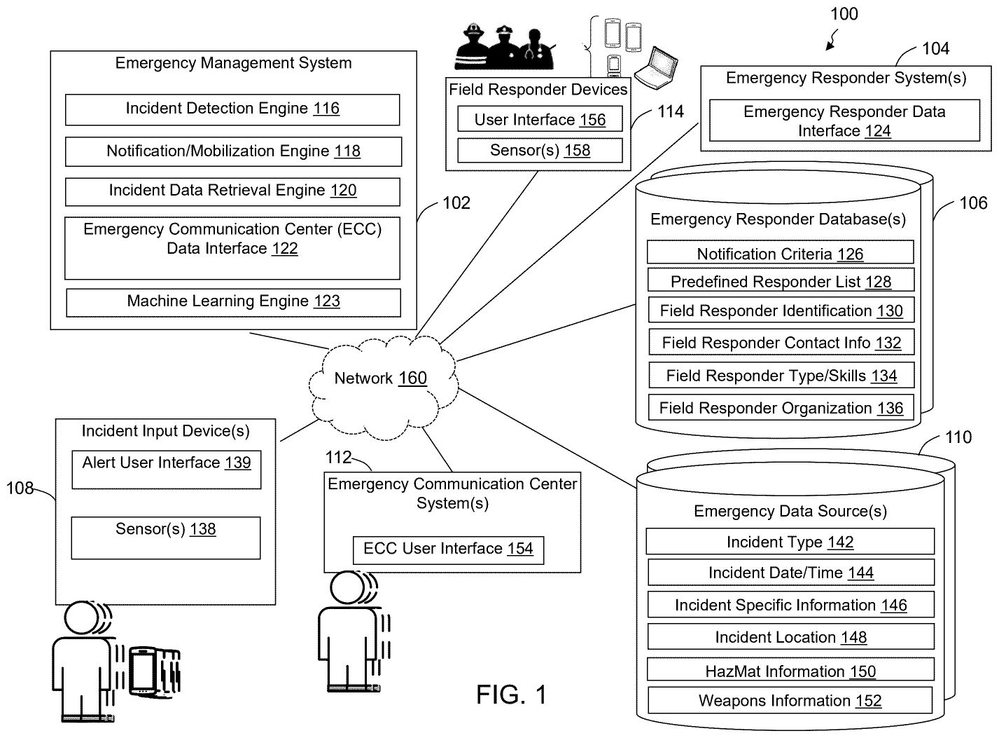

Turning now to the figures, FIG. 1 shows an exemplary emergency management provider system (EMPS) 100 that may implement one or more of the methods, processes, and emergency response protocols described herein. In embodiments, the EMPS 100 may include a network 160, one or more incident input devices 108, an emergency management system (EMS) 102, an emergency communication center (ECC) system 112, an emergency responder system (ERS) 104, an emergency responder database 106, first responder devices 114, and emergency data sources 110, described below.

In some approaches, the system components may be communicatively coupled, either directly or indirectly, such as over one or more distributed communication networks 160, which may include, for example, LAN, WAN, Internet, Wi-Fi, cellular, and other such communication networks or combinations of two or more of such networks.

The one or more incident input devices 108, in some examples, may be used to input an incident to initiate an emergency alert for generating an emergency response. In some approaches, the incident input devices 108 are electronic devices associated with a user involved with, at the scene of, or having knowledge of the incident. In some approaches, the incident input devices 108 are associated with monitoring agencies or a rail network operations center (NOC) for monitoring incidents on railways (e.g., a monitoring agency inputs the incident data). In some embodiments, the incident input device 108 may be associated with an ECC which inputs the incident data (e.g., after receiving a phone call about the incident).

Such devices 108 may be digital processing devices and/or communication devices, e.g., a mobile or cellular phone such as a smart phone, a tablet, computer, laptop, etc. In some embodiments, the device 108 is a portable or wearable device (e.g., a smartwatch). In some embodiments, the device 108 is an Internet of Things (IoT) device, such as a home assistant (e.g., an Amazon Echo) or a connected smoke detector (e.g., a Nest Protect smoke and carbon monoxide alarm). The device 108, in some approaches, may be associated with a home security system or with a vehicle console for initiating incidents that occur within a home or vehicle. In some embodiments, more than one device is used to coordinate transmission of an emergency alert. Generally, the incident input device 108 may include one or more of a display, a processor, a memory and data storage, a network component, a user interface, and programming or program code to initiate an incident or emergency alert.

In some embodiments, the incident input device 108 includes one or more sensors 138. For instance, the incident input device 108 may include one or more health or environmental sensors. In some embodiments, for instance, the one or more sensors 138 include, but are not limited to: a gyroscope, an accelerometer, a thermometer, a heart rate sensor, a barometer, or a hematology analyzer. In some embodiments, the one or more sensors 138 detect light, motion, temperature, pressure, humidity, vibration, magnetic field, sound, smoke, carbon monoxide, radiation, hazardous chemicals, acid, base, reactive compounds, volatile organic compounds, smog, or any combination thereof. In some embodiments, the sensor data is compiled from at least one sensor associated with an automatic alarm. Other sensors may include, for example, location sensors (e.g., GPS), image sensors (e.g., camera/video), audio sensors, fall detection sensors, home security sensors, motion sensors, vehicle crash detection sensors, train derailment sensors, etc. In some approaches, the sensors 138 may be located within the device 108 or communicative with or coupled thereto. For instance, in some examples, devices such as a smartwatch or heart rate monitor may transmit sensed data to another incident input device 108 (e.g., through Bluetooth or other suitable wireless connections).

An incident or alert (i.e., a request for assistance) may be initiated via the incident input device 108 in various ways, according to different embodiments. For instance, in some approaches the incident input device 108 is used to initiate a voice call or message (such as an SMS text or data message or email). In some approaches, the voice call or message is a 911 call or message which may be received directly by the ECC system 112 or may be received and/or routed through the EMS 102. In illustrative embodiments, the incident input device 108 includes an alert user interface 139 for initiating an electronic alert. In some approaches, the alert user interface 139 may be provided at least in part by a program, application, mobile application, or portal programmed to allow a user to initiate an alert, such as by pressing a button, sending a message, initiating a voice call, inputting information about an incident, or setting criteria or settings for triggering an alert. The alert user interface 139 and program or application may be configured to facilitate a user's generation of an electronic alert or request for assistance to the EMS 102 and/or to an ECC. In some approaches, the alert user interface 139 may include a communication or chat interface to enable a two-way text-based chat session. The communication interface may also permit voice exchange or exchange of other media (e.g., photos, videos, etc.). The program or application may also be configured to record, store, and transmit user data, such as a name, address, phone number, or medical data of a user associated with the incident input device 108 or associated with a user account associated with and/or accessed through the incident input device 108. The program or application may also be configured to record, store, and transmit a current location of the incident input device 108.

In some approaches, the program or application may be an emergency or safety program or application (e.g., ECC user interface 154) associated with the EMS 102. In some embodiments, the application may be programmed to integrate data, features, and functionality of the EMS 102 via an Application Programming Interface (API) or API plug-in. In some embodiments, the application may be hosted by or communicatively coupled to (e.g., using a WebSocket) EMS 102. In some embodiments, the application may be provided by a third-party service provider. For instance, in illustrative approaches, the application may be provided by a ride-share service provider, a medical services provider, a home security provider, or others. In some embodiments, the application may be provided on a vehicle console and provided by the EMS 102 or provided by third-party service providers (e.g., OnStar or other similar vehicle subscription services, radio subscription services such as SiriusXM, navigation/map services, etc.). In such embodiments, an incident or alert may be generated at the incident input device 108 via the third-party application such that third party servers (not shown) communicate the alert to the ECC system 112 and/or to the EMS 102. In some approaches, the alert user interface 139 may be provided as a portal used by monitoring agencies or a rail network operations center (NOC) for monitoring incidents on railways.

In embodiments, the emergency management system (EMS) 102 is a central server-based system that receives, manages, and routes electronic alerts (e.g., after they are initiated by incident input devices 108) to coordinate an emergency response. The EMS 102 may include one or more network or communication elements for connecting to central network 160, an operating system, one or more servers, a CPU, a memory unit, databases and one or more programs or software modules or engines executing program code for implementing the data interfaces, user interfaces, software/cloud-based/web applications, methods, functions, and flowcharts provided herein. The CPU may be implemented as one or more microprocessors, microcomputers, microcontrollers, digital signal processors, central processing units, state machines, logic circuitries, and/or devices that manipulate signals based on operational instructions. Among other capabilities, the CPU is configured to fetch and execute computer-readable instructions stored in the memory unit. The memory unit optionally includes any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory unit optionally includes modules, routines, programs, objects, components, data structures, etc., which perform particular tasks or implement particular abstract data types.

The EMS 102, in embodiments, may include one or more of an incident detection engine 116, a notification/mobilization engine 118, an incident data retrieval engine 120, an emergency communication center (ECC) data interface 122, and a machine learning engine 123. The incident detection engine 116 may execute programming or program code to receive, detect and/or determine new incidents or alerts. For instance, the incident detection engine 116 may process an alert or notification of an incident received from one or more of the incident input devices 108. The incident detection engine 116 may, in some approaches, determine the validity of the alert. In some embodiments, the incident detection engine 116 may receive multiple alerts or notifications from different incident input devices 108 and determine that the multiple alerts or notifications are associated with a single or common incident. The incident detection engine 116 may combine the alerts into a single alert and/or tag the alerts with a common identifier.

In some embodiments, the incident detection engine 116 receives an electronic alert (e.g. from an incident input device 108) that contains information associated with the alert. For instance, in some approaches, the incident detection engine 116 receives the alert via an HTTP post or API action. In some embodiments, the alert includes, at least, an alert notification. The alert may include a location (e.g., a device-based hybrid location) or other location data generated by or for the incident input device 108, or which may be input by a user when creating the alert. In some embodiments, the alert contains other data such as user data (e.g., name, phone number, medical history), a category and/or description of the incident, and/or one or more user messages input by a user of the incident input device 108.

In some embodiments, the incident detection engine 116 assigns an alert identifier to the incident or alert. The alert identifier may be associated with any and/or all of the information contained in the alert (e.g., messages, user data, sensor data, logistical information (date, time, location of alert), etc.). Specifically, the alert identifier tracks all data payloads that belong to the same alert incident, ensuring that all pieces of information related to a specific incident can be correlated and managed effectively. In some approaches, the alert identifier may be system-generated at the source of the alert. That is, the system that is the initial source of the alert (such as a third party service provider or device) generates a unique identifier to ensure all related data points are linked to the same incident. In other approaches, the system that receives the alert data (e.g., the EMS 102) generates the alert identifier, creating its own identifier to track information associated with the incident. In some embodiments, the identifier is a mobile phone number or an alpha-numeric identifier associated with an incident input device 108 or a user account. In some approaches, the identifier is an identifier of an incident input device 108 and becomes associated with an emergency call or text-to-911 routed to the ECC system 112 or emergency responder 104.

In some approaches, the incident detection engine 116 may receive or assign one or more emergency categories to the alert (e.g., car accident, home security event, fire, etc.), which may determine, at least in part, the specific emergency response protocol to implement in the scenario and/or determine an appropriate ECC 112 and/or emergency responder 104 to handle the response.

The incident detection engine 116 may also receive or consolidate information from different sources to associate with the alert. For instance, in some embodiments, the incident detection engine 116 communicates with the incident data retrieval engine 120, which sources data related to the alert or incident. In some approaches, the incident data retrieval engine 120 receives data pertaining to an alert from emergency data sources 110 or databases that may be associated with or relevant to the alert and/or associated with the incident input device 108 or with a user or user account associated with the incident input device 108. In some approaches, the incident data retrieval engine 120 queries internal data sources or external data sources or sensors that, for instance, may be associated with a location of the incident, with the user, or with the user electronic device to attain additional contextual information.

In some approaches, the incident detection engine 116 and/or incident data retrieval engine 120 receives information such as one or more of incident type or category 142, incident date/time 144, additional incident specific information 146, incident location 148, HazMat information 150, and weapons information 152 from emergency data sources 110 such as the incident input device 108. In various embodiments, the emergency data sources 110 may include contextual or sensor data. In some approaches, the incident data retrieval engine 120 requests contextual or sensor data from one or more of the emergency data sources 110. For instance, in one approach, a data request is a geospatial query (automatically transmitted or manually submitted) through a graphical user interface of the EMS 102 (e.g., accessed via an ECC system 112). The requested data may include data from available sensors or data sources within a radius defined by the geospatial query. The requested and collected data may be associated with the specific alert via the alert identifier. In some embodiments, the data request is automatically transmitted from the EMS 102 in response to the EMS 102 detecting an incident or alert.

In some embodiments the contextual data sources may, for example, provide sensor data (e.g., real-time sense data), camera data, emergency call data, medical/health data, law enforcement data, weather data, demographic data, multimedia or news data (e.g., from news feeds), and/or geolocation data. In embodiments, the contextual information includes historical data and/or real-time or current data. In exemplary embodiments, the EMS 102 may further include a clearinghouse such as that described in U.S. Pat. No. 11,902,871, the contents of which are incorporated by reference herein in its entirety. The clearinghouse is an input/output (I/O) interface configured to manage communications and data transfers to and from the EMS 102 and external systems and devices. In some embodiments, the clearinghouse facilitates multiple communications within a wide variety of networks and protocol types, including wired networks, for example, LAN, cable, etc., and wireless networks, such as WLAN, cellular, or satellite.

In some approaches the incident detection engine 116 or other engines or modules of the EMS 102 may determine or generate what may be referred to as a “pre-alert” package of data that the EMS 102 may automatically transmit to an ECC 112, emergency responder system 104, and/or specific field responders prior to the ECC 112, emergency responder system 104, and/or specific field responders officially accepting and/or being assigned responsibility to handle the alert. In some embodiments, the “pre-alert” data package includes one or more of incident type or category 142, incident date/time 144, additional incident specific information 146, incident location 148, HazMat information 150, and weapons information 152 from emergency data sources 110 such as the incident input device 108. Information such as health profiles, vehicle telematics, and sensor information can also be included. In some approaches, the pre-alert incident data in any of the methods described herein may include determined information regarding recommended response actions including at least one of recommended response units, gear, and precautions. In some embodiments, the recommended response actions are based on at least one of: type of event, location, weather, topography, climate, individuals impacted, and/or facilities involved.

As used herein, a pre-alert data package is typically distinct from data used solely for training as the pre-alert data package is typically in preparation for a specific potential dispatch and may include information about the present circumstances on the ground and even likely developments. In this manner, the pre-alert data package may be used to prime or prepare the emergency responders. This may include, for example, review of relevant protocols, procurement of particular gear or equipment, coordination with other responders, review of weather patterns for a particular location, etc. In this manner, by priming the emergency responders (and the system) for anticipated dispatch to a particular location, under particular circumstances, and under likely anticipated conditions (e.g., wind, rain, snow, among a myriad of other conditions), the emergency responders may be more effective and efficient in their potential, eventual dispatch.

When the ECC 112, emergency responder system 104, and/or specific field responders receives pre-alert data ahead of time, this increases the situational awareness and readiness of these entities so that they can effectively respond to the alert if or when they are assigned or take up responsibility for the alert, as described further below.

In an illustrative approach, such pre-alert data is automatically transmitted to an ECC system 112 while a user of an incident input device 108 is still waiting for a call (or text-based communication session) to go through to the ECC system 112. For instance, in one approach, the user may be on hold with an emergency communications center after dialing 9-1-1, but the pre-alert data is automatically associated with the incident or alert and sent to the ECC system 112 prior to the call going through or getting picked up by an ECC telecommunicator, dispatcher or other personnel/agents. In some embodiments, the pre-alert data is displayed on an ECC user interface 154 so that it may be visible to personnel prior to taking or accepting the call.

The emergency communication center (ECC) data interface 122 may, in some approaches, be an electronic data interface that facilitates communication with and management of the ECC system 112 by the EMS 102. In some embodiments, the ECC data interface 122 comprises a program, application, mobile application, or electronic portal that can be executed on or accessed by a user interface 154 of a computing device associated with the ECC system 112. In some approaches, the ECC data interface 122 is a software, cloud-based, or web application either installed on a computing device associated with the ECC system 112 or accessed via the internet through a web browser on the computing device. In some embodiments, the ECC data interface 122 is an application hosted on a cloud computing system by the EMS 102. Generally, the ECC data interface 122 may function to facilitate communication links between the user and/or incident input device 108 initiating the alert, the EMS 102, and the ECC system 112 and provide access to alert-related data and alert management and routing options. The ECC data interface 122 optionally includes various components, such as a frontend application or graphical user interface, for example, accessed on a computing device of the ECC system 112, a backend application, an authorization module, and a user database. Any or all of the components of the ECC data interface 122 may be hosted on a cloud computing system by the EMS 102, a computing device associated with the ECC system 112, or some combination thereof. In an embodiment, a cloud application is operatively coupled to various ECCs. For example, the cloud application provides an instance of ECC data interface 122 to an ECC network entity (e.g., a computing device) via a portal graphical user interface executing on a web browser or locally installed application instance. Multiple ECCs may operate multiple instances of the cloud application and each network entity may display and operate the portal graphical user interface.

The ECC data interface 122 may be configured to display on a graphical user interface information related to specific alerts, lists of current and/or historical alerts, maps for displaying alert locations, options for communication or response such as dispatch options, messaging, or sharing of information, options for requesting information, and other features. The ECC data interface 122 may also be configured to display pre-alert information associated with alerts prior to a call being picked up by the ECC system 112.

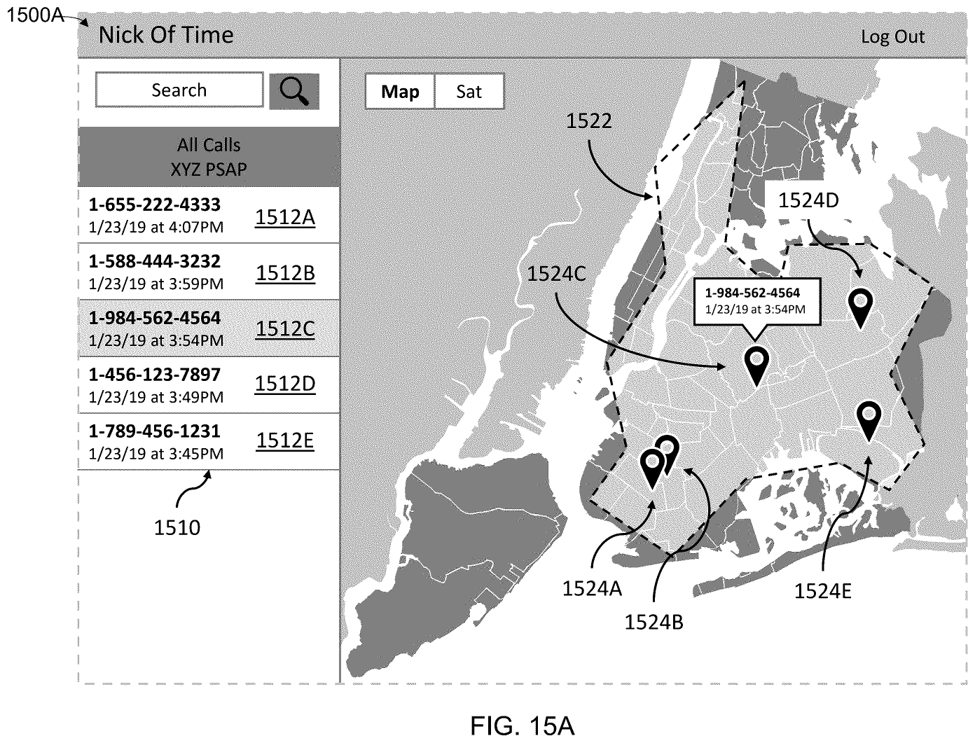

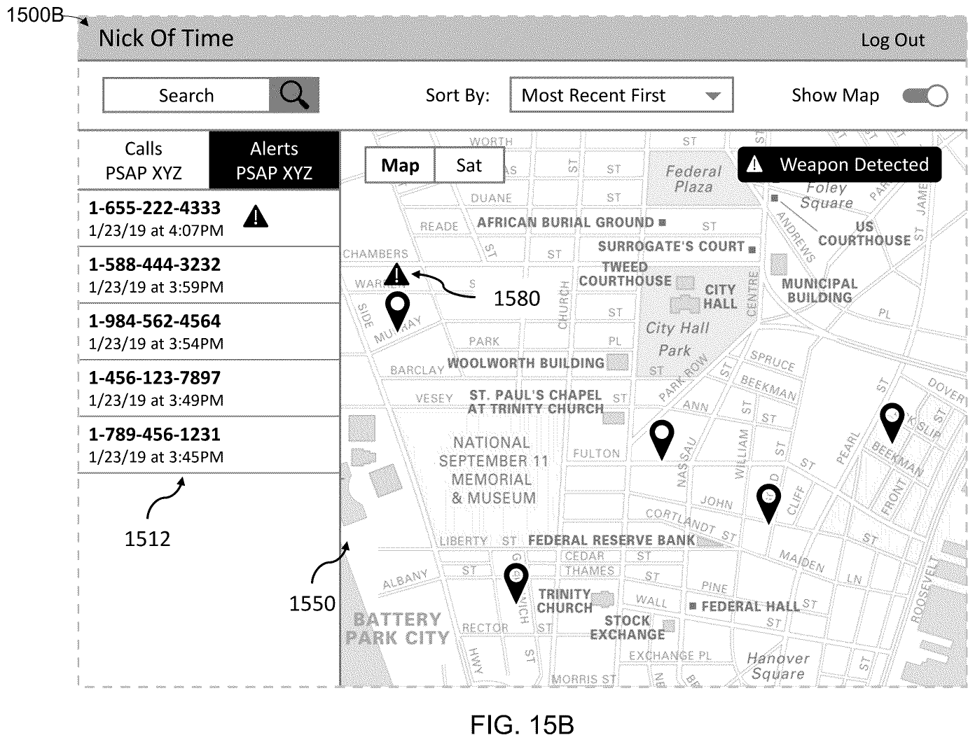

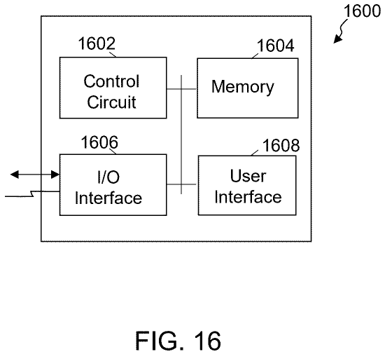

Exemplary ECC data interfaces that display incident data are shown in FIGS. 15A and 15B. FIG. 15A shows an ECC user interface 1500A with a graphical user interface 1560 that displays incident data for a plurality of calls or alerts 1512A, 1512B, 1512C, 1512D, 1512E that are displayed in a list or queue 1510. The location of each call or alert is displayed on an interactive map 1522, at locations 1524A, 1524B, 1524C, 1524D, and 1524E. In some embodiments, alerts that are displayed at a specific ECC may depend on the location of the alert or incident and any jurisdictional or coverage boundaries associated with the specific ECC. For instance, the EMS 102 may route alerts to a specific ECC when the location of the alerts is within the predefined coverage area of the ECC. In some approaches, the EMS 102 may route alerts to a specific ECC based on both location and type/category of alert. FIG. 15B shows an ECC user interface 1500B with a graphical user interface that displays a list or queue of calls or alerts 1512 in one section and a map 1550 in another section that marks the locations of the alerts. In some approaches a specific symbol on the map 1550 may indicate a specific level, risk, and/or other attribute of the alert. For instance, as shown, a caution symbol 1580 on the map 1550 and in the list 1510 of alerts indicates that a weapon has been detected.

With reference again to FIG. 1, the notification/mobilization engine 118 of the EMS 102 may execute program code to determine and transmit alert notifications to various recipients. For instance, in one approach, the notification/mobilization engine 118 determines which ECC system 112 an alert should be routed to, based, for instance, on the location of the alert and the type or category of alert. For example, as noted above, different emergency communication centers may be associated with specific jurisdictional/coverage boundaries, and the notification/mobilization engine 118 may determine which emergency communication center to receive an alert notification based on whether the alert location is within the emergency communication center's predetermined coverage area. The notification/mobilization engine 118 may also determine whether alert notifications should be transmitted to one or more emergency responder systems or providers 104, described further below. In some approaches, the notification/mobilization engine 118 may also determine whether alert notifications should be transmitted directly to emergency responder or field responder devices 114. In some cases, these alert notifications to the selected emergency responder systems 104 and/or field responder devices 114 contain certain information about the alert or incident (e.g., incident type, location, specific details, date/time, HazMat information, weapons information) prior to receiving an official dispatch order from the ECC system 112 to facilitated preparedness for response.

In some approaches, the notification/mobilization engine 118 may communicate with one or more databases of emergency communication centers and/or emergency responders to determine appropriate entities and/or personnel to receive alert notifications for an alert. In some embodiments, emergency responder databases 106 include information associated with emergency responder providers, field responder providers, and/or individual emergency or field responders, such as field responder name/identification 130, field responder contact information 132, field responder type and/or skills 134, and field responder organization 136. In some embodiments, the emergency responder provider has authorized sharing of incident data with the specified responders, for instance on a general basis or with respect to certain types of incidents. In some embodiments, the emergency responder databases 106 include notification criteria 126 that is communicated to the notification/mobilization engine 118, the notification criteria including predefined rules to determine when the emergency responder provider and/or specific field responders should receive alert notifications. For instance, the notification criteria 126 may associate the emergency responder provider, specific field responders, or predefined lists of field responders, with specific types/categories of alert, specific urgency levels, specific locations, specific expertise/skills needed, specific equipment needed, specific days or times, etc. In some approaches, the emergency responder database 106, for instance, includes one or more predefined responder lists 128 that lists a specific group of field responders to which notifications should be sent during an alert depending on the type of alert and/or any of the above-mentioned factors.

In some embodiments, the notification criteria 126 include timing rules, such as whether the alert notification should be sent to the field responders before, concurrently with, and/or after the field responders receive an official dispatch order from an emergency communication center, or before, concurrently with, or after the ECC system 112 receives the alert. That is, in some examples, the notification criteria 126 specify whether certain responders are eligible to receive notifications containing “pre-alert” information. Notification methods are described further below.

The EMS 102 also, in some approaches, includes a machine learning engine 123. The machine learning engine 123, in various embodiments, may include one or more machine learning models having one or more machine learning algorithms to carry out various functions. For instance, a machine learning model may be leveraged to analyze alert data or information that is received for a specific alert and make determinations regarding the type of alert, the type of response needed, and the routing of the alert to responders. In some approaches, for instance, the model determines information regarding recommended response actions including at least one of recommended response units, gear, and precautions that may be transmitted to field responders (e.g., as “pre-alert” information) in any of the methods described herein. In some embodiments, the recommended response actions are based on at least one of type of event, location, weather, topography, climate, individuals impacted, and/or facilities involved.

In some approaches, the other engines of the EMS 102, such as the incident detection engine 116, notification/mobilization engine 118, incident data retrieval engine 120, and ECC data interface 122 communicate with the machine learning engine 123 to make determinations and carry out the functions of these engines with greater accuracy. In embodiments, the machine learning models are trained on historical alerts, for example, historical alert information associated with historical alerts as well as historical data regarding response and resolution to the historical alerts.

In some approaches, the machine learning model may include a natural language processing model selected from recurrent neural networks, long short-term memory networks, and transformer models. Natural language processing and/or natural language understanding may be implemented to determine the literal and/or intended meaning of user messages. For instance, user messages input during an alert may be parsed to determine the type of incident, the urgency of the incident, the location of the incident, etc. The machine learning model or natural language processor may be used to transcribe or summarize live 911 call audio to determine a natural and location of an emergency, or other information. The transcript, summary, nature, and/or location of the incident may be used to generate the pre-alert or alert, according to some approaches.

As noted above, the system 100 further includes one or more emergency communication center (ECC) systems 112 as well as one or more emergency responder systems 104. The ECC system 112 may include one or more emergency communication centers (ECC), which may be primary agencies such as public safety answering points (PSAP), secondary agencies (such as police or fire departments), regional agencies (a statewide or federal agency), etc. An ECC may have telecommunicators, dispatchers and/or other monitoring agents that triage 911 calls and/or alerts and dispatch field responders. Many or most of the communication and dispatching functions may occur on computing and/or communication devices of the ECC system 112. For instance, telecommunicators and/or dispatchers may utilize an ECC user interface 154 on a computing device to respond to voice or text calls or alerts, view information and data associated with alerts, view mapped locations of alerts, and view and select options for routing, dispatch, and response. In some approaches, the ECC user interface 154 includes, executes, or provides access to the ECC data interface 122 of the EMS 102, which may, as discussed above, be an application or portal provided by the EMS 102. Thus, agents can directly access alert information and data provided by the EMS 102 by accessing the ECC data interface 122, as well as use the ECC data interface 122 to coordinate the response. Several ways in which the ECC data interface 122 is used to coordinate a response and/or share information with field responders are discussed below.

The emergency responder system 104 includes one or more emergency responder providers, also referred to herein as emergency service providers (ESPs) or field response providers. These providers may be any entity or group that is associated with one or more field responders, such as a police department or paramedics. In some approaches, one or more emergency responder providers may receive dispatch orders from the ECC system 112 to respond to an alert or incident. The emergency responder providers may also receive alert information from the EMS 102 and/or from the ECC system 112, which, in different embodiments, may occur before, concurrently with, and/or after receiving a dispatch order.

In some approaches, the emergency responder system 104 includes an emergency responder data interface 124 in communication with the network 160. The emergency responder data interface 124 may be communicative with one or more of the EMS 102, the ECC system 112, the ECC data interface 122, emergency responder databases 106, and field responder devices 114. In some embodiments, the emergency responder data interface 124 is a program, application, mobile application, or electronic portal that can be accessed by or executed on computing devices associated with the emergency responder system 104 (such as, for example, field responder devices 114).

In some approaches, the emergency responder data interface 124 is a software application either installed on a computing device or accessed via the internet through a web browser on the computing device. In some embodiments, the emergency responder data interface 124 is an application hosted on a cloud computing system by the EMS 102. Generally, the emergency responder data interface 124 may facilitate communication with the EMS 102 and/or the ECC system 112 and provide access to alert-related data. In some cases, the emergency responder data interface 124 may facilitate communication with the user and/or incident input device 108 initiating the alert (e.g., via an option to initiate a voice or text communication session). The emergency responder data interface 124 optionally includes various components, such as a frontend application or graphical user interface, for example, accessed on a computing device of the emergency responder system 104, a backend application, an authorization module, and a user database. Any or all of the components of the emergency responder data interface 124 may be hosted on a cloud computing system by the EMS 102, a computing device associated with the emergency responder system 104, or some combination thereof.

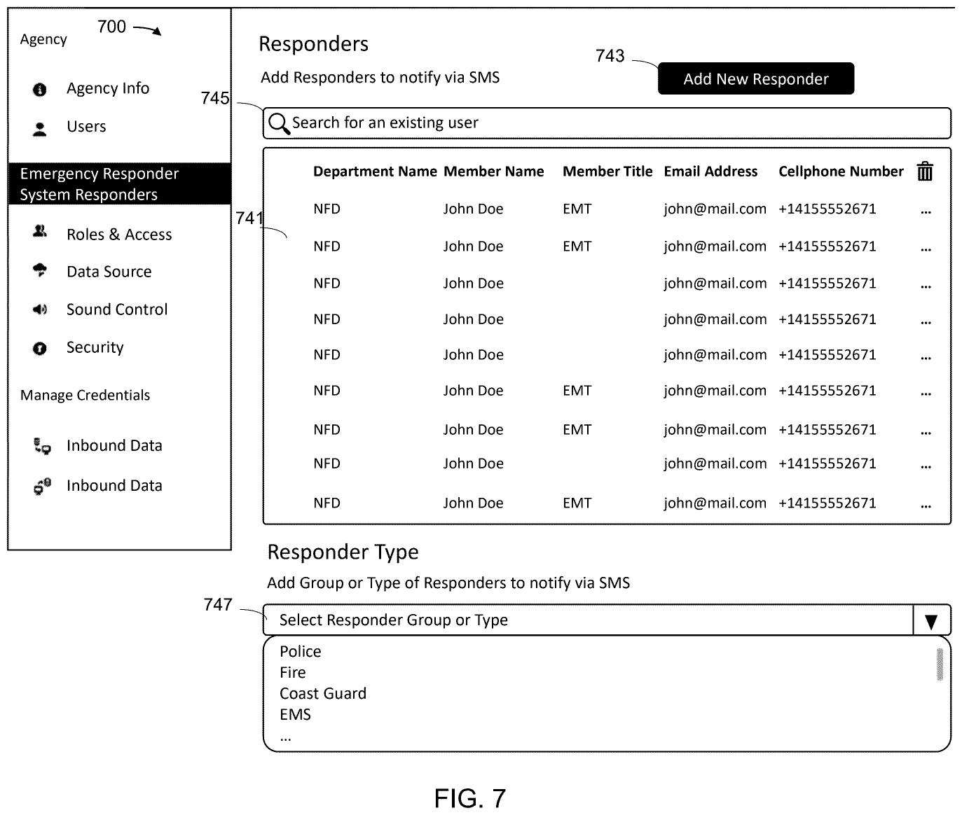

The emergency responder data interface 124, in some approaches, may be accessed by agents associated with the emergency responder system 104. In some cases, field responders can access the emergency responder data interface 124 on field responder devices 114. The emergency responder data interface 124 may be configured to display on a graphical user interface information related to specific alerts, alert notifications, lists of current and/or historical alerts, maps for displaying alert locations, options for communication or response such as dispatch options, messaging, or sharing of information, options for requesting information, and other features. The emergency responder data interface 124 may, in some cases, display pre-alert information associated with alerts prior to receiving a dispatch order (e.g., from the ECC system 112) or receiving responsibility to respond to the alert. In some approaches, the emergency responder data interface 124 may also include options to update or revise the emergency responder database 106. For instance, as shown in FIG. 7 (described further below), there may be options to add or delete responders and/or create new or modified predefined lists of field responders to receive notifications during an alert.

The system 100 further includes one or more field responder devices 114 associated with field responders. For instance, in some approaches, field responders may have personal electronic communication devices 114 (e.g., mobile phones, smartphones, tablets, laptops, computers, etc. with cellular, Wi-Fi, Bluetooth, peer-to-peer connectivity, or other wireless connectivity) that are capable of receiving alert/pre-alert notifications and alert/pre-alert information, as well as dispatch orders. For instance, in some embodiments, the devices 114 are configured to receive SMS/MMS or HTTP text messages so that alert notifications can be sent via messaging. The devices 114 may also be configured to receive alert notifications via email or through voice calls or voice messages. In some approaches, the devices 114 permit access to the emergency responder data interface 124 for receiving alert notifications and information about the alert. For instance, the emergency responder data interface 124 may be configured as a mobile application executed on a mobile first responder device 114, so that the first responder can access the above-described functions of the emergency responder data interface 124.

Generally, the field responder devices 114 may include, at least, one or more of a display, a processor, a memory and data storage, a network component, a user interface 156, and programming or program code to receive and display alert notifications and alert information. In some approaches, the field responder devices 114 include or communicate with one or more sensors 158. For instance, the field responder device 114 may have GPS capability and communicate a current location of the device 114 to the emergency responder system 104 and/or to the EMS 102 for effective coordination of the response. In some approaches, the field responder devices communicate with and receive input from sensors 158 such as health or environmental sensors. In some embodiments, for instance, the sensors 158 include, but are not limited to: a gyroscope, an accelerometer, a thermometer, a heart rate sensor, a barometer, or a hematology analyzer. In some embodiments, the sensors 158 detect light, motion, temperature, pressure, humidity, vibration, magnetic field, sound, smoke, carbon monoxide, radiation, hazardous chemicals, acid, base, reactive compounds, volatile organic compounds, smog, or any combination thereof. In some embodiments, the sensors are image sensors (e.g., camera/video) and/or audio sensors. In some approaches, the field responder devices 114 may transmit sensor data received from the one or more sensors 158 to the emergency responder system 104 and/or to the EMS 102 to provide additional situational or contextual information regarding the incident to further coordinate the response.

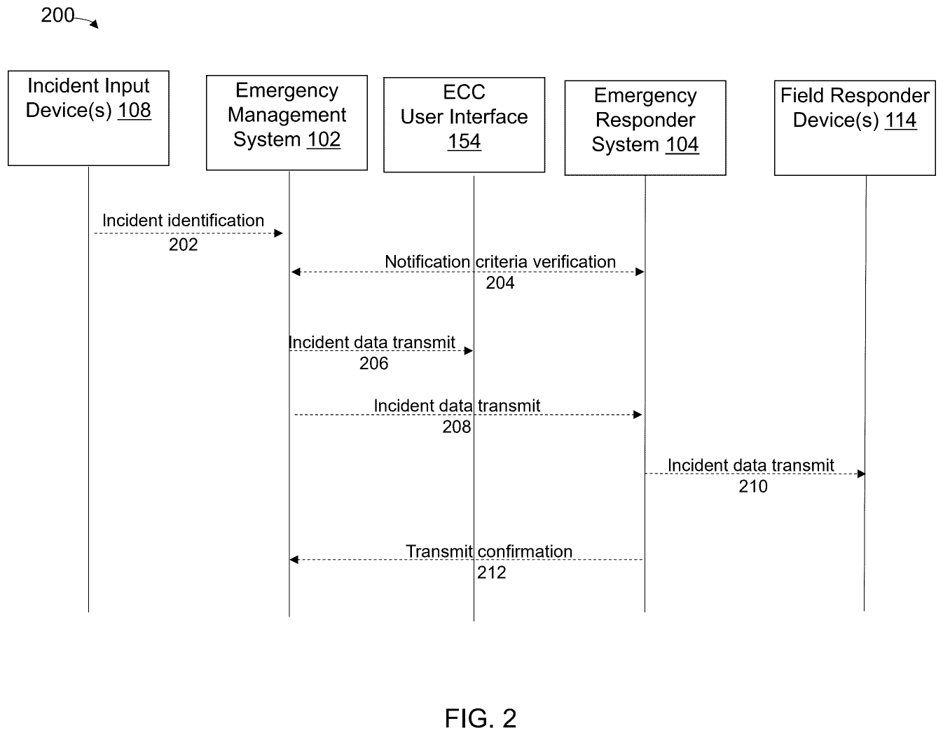

With reference to FIG. 2, an exemplary method 200 for an emergency response protocol for sharing incident data with field responders is illustrated. The method 200 may be used to distribute incident data associated with an incident or alert to one or more field responders. More specifically, the method 200 includes various workflows between one or more incident input devices 108, the emergency management system 102, the ECC user interface 154 (which may execute an application or portal of the ECC data interface 122 of the EMS 102), the emergency responder system 104, and one or more field responder devices 114.

At incident identification step 202, the EMS 102 receives incident or alert data for an incident from an incident input device 108. The incident data includes a location associated with the incident, which, in some approaches, may be a current GPS location, and may include other information associated with the incident (e.g., a name of the user of the device 108 or persons involved in incident, a type or description of the incident, sensor data, etc.). As discussed in more detail above, in non-limiting embodiments identifying an incident may include making a 911 call from the incident input device 108 or using an alert application or program to initiate an alert.

At step 204, the EMS 102 and the emergency responder system 104 communicate to establish and/or verify notification criteria. For instance, in some approaches, the emergency responder system 104 provides the EMS 102 with a jurisdictional boundary defining a coverage area for a specific emergency responder or field response provider, for example via an API. The jurisdictional boundaries may be in the form of one or more files. The jurisdictional boundary may be, for example, geographical boundaries for a fire department or police department or may be for a particular geographic area such as a city, state, county, or region. In some approaches, step 204 may occur prior to step 202. In some examples, the notification criteria may initially be communicated to the EMS 102 prior to step 202 but verification or confirmation of the notification criteria may occur after step 202.

In some approaches, the notification criteria that are established and/or verified may be notification criteria 126 that are received from the emergency responder data interface 124 and/or from the emergency responder database 106 (See FIG. 1). These criteria or rules, as discussed above, determine the emergency responder provider and/or specific field responders to receive alert notifications, associating the emergency responder provider, specific field responders, or predefined lists of field responders, with specific types/categories of alert, specific urgency levels, specific locations, specific expertise/skills needed, specific equipment needed, specific days/times, etc. As discussed above, the criteria may include timing rules for receiving alert or pre-alert information.

For instance, the notification criteria may indicate whether the alert notification should be sent to the field responder provider or field responders before, concurrently with, or after the field responder provider or field responders receive an official dispatch order from an ECC, and/or before, concurrently with, or after an ECC system 112 receives the alert. Thus, in some approaches, notification criteria is verified at step 204 to confirm whether certain responders are eligible to receive notifications containing “pre-alert” information.

At step 206, the EMS 102 may transmit incident or alert data to the ECC user interface 154 of an ECC computing device. In some approaches, as discussed above, the ECC user interface 154 may access the incident data by accessing a graphical user interface of the ECC data interface 122 (see FIG. 1). The specific emergency communications center may be selected by the EMS 102 based at least on a location of the alert. For instance, as noted above, selection of a specific emergency communications center may depend on whether the incident location is within the coverage area of the emergency communications center. In cases where the incident is reported in the form of a 9-1-1 call, the incident data may be received at the ECC user interface 154 as a “pre-alert” prior to the call being picked up by an agent so that incident data is ready and accessible.

At step 208, the EMS 102 may transmit incident data to the emergency responder system 104. For instance, when the notification criteria of the emergency responder system 104 specifies that the emergency responder system 104 is eligible to receive “pre-alerts”, the EMS 102 may transmit the incident data to the emergency responder system 104 prior to the emergency responder system 104 receiving an official dispatch order. In some approaches, the EMS 102 automatically sends the incident data to the emergency responder system 104. In these approaches, this may occur concurrently or substantially with the incident data being transmitted to the ECC user interface 154. That is, incident data or “pre-alerts” may automatically be sent to the ECC user interface 154 and the emergency responder system 104 at about the same time, shortly after the alert is received by the EMS 102.

In various approaches, the alert and/or pre-alert is sent to the ECC user interface 154 and/or the emergency responder system 104 or field responder devices 114 within 2 minutes, within 1 minute, within 50 seconds, within 40 seconds, within 30 seconds, within 20 seconds, within 10 seconds, or within 5 seconds after the EMS 102 receives the incident.

In some approaches, the EMS 102 transmits incident data to the emergency responder system 104 after the incident data is sent to the ECC user interface 154. For instance, in some embodiments, an agent monitoring the ECC user interface 154 is presented an option to share the incident data with the emergency responder system 104 or to specific field responder devices 114 (detailed further below), so the EMS 102 transmits incident data to the emergency responder system 104 after the agent selects to share the data. In some approaches, the EMS 102 may transmit incident data to the emergency responder system 104 before the incident data is sent to the ECC user interface 154. In some approaches, notification criteria may permit some “pre-alert” incident data to be sent to the emergency responder system 104 or field responders, while additional incident data is sent to the emergency responder system 104 or field responders only after a discharge order is received by the emergency responder system 104 or by specific emergency responder providers or field responders. In some examples, notification criteria may permit some field responders to receive “pre-alert” incident data while other field responders are only eligible to receive alert data after an official dispatch order is received. As discussed above, when received by the emergency responder system 104, the incident data (e.g, in the form of an alert or pre-alert) may be displayed on a graphical user interface of an emergency responder data interface 124 (See FIG. 1) executed by a computing device.

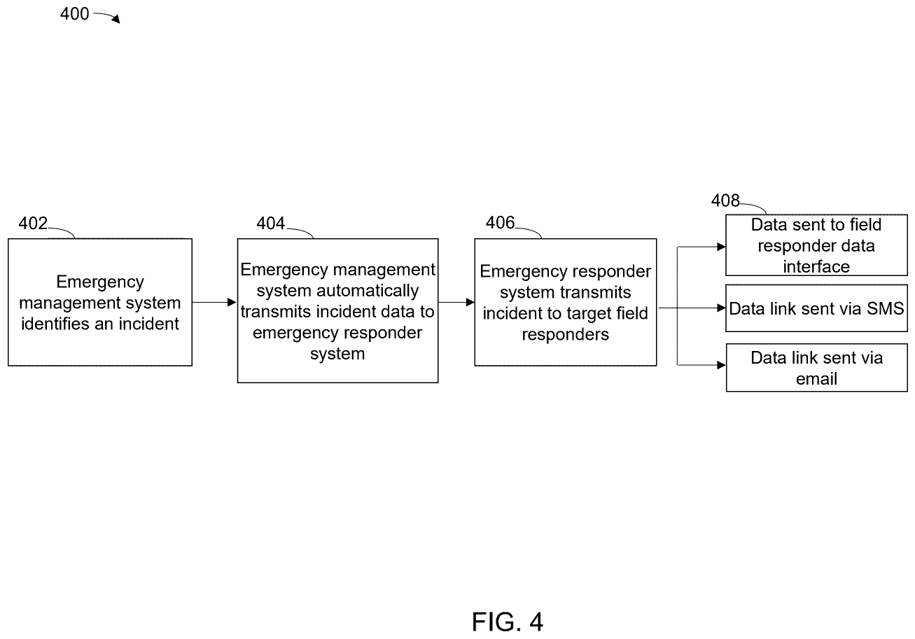

At step 208, the emergency responder system 104 may transmit the incident data to one or more field responder providers and/or individual field responder devices 114. Various methods for distributing incident data to field responders and/or field response providers are shown and described with reference to FIGS. 4-6. In some approaches, the emergency responder data interface 124 transmits the incident data automatically to the field responder providers and/or field responder devices 114. In some embodiments, an agent monitoring a graphical user interface of the emergency responder data interface 124 selectively transmits the incident data automatically to the field responder providers and/or field responder devices 114. In other approaches, the EMS 102 transmits the incident data directly to the field responder providers and/or individual field responder devices 114. As discussed above, the specific field responder devices 114 for receiving alert or pre-alert incident data, in some examples, may be predefined, and may depend on various factors such as location of alert, type of alert, hazardous materials, equipment needed, field responder type/skills, on duty schedule, etc.

At step 212, the emergency responder system 104 may transmit confirmation to the EMS 102 that the alert or pre-alert incident data was successfully transmitted to one or more field responder providers and/or individual field responder devices 114. In some approaches, the confirmation may include a confirmation that the data was viewed by the targeted providers or filed responder devices. In illustrative embodiments, the EMS 102 may receive a count (e.g., the number of) field responders to which the incident data was transmitted. In some approaches, the EMS 102 may receive a timestamp indicating times at which the incident data was transmitted and/or times at which the incident data was viewed.

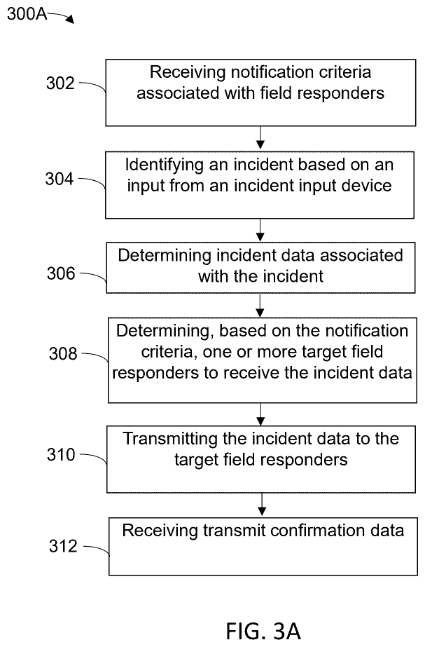

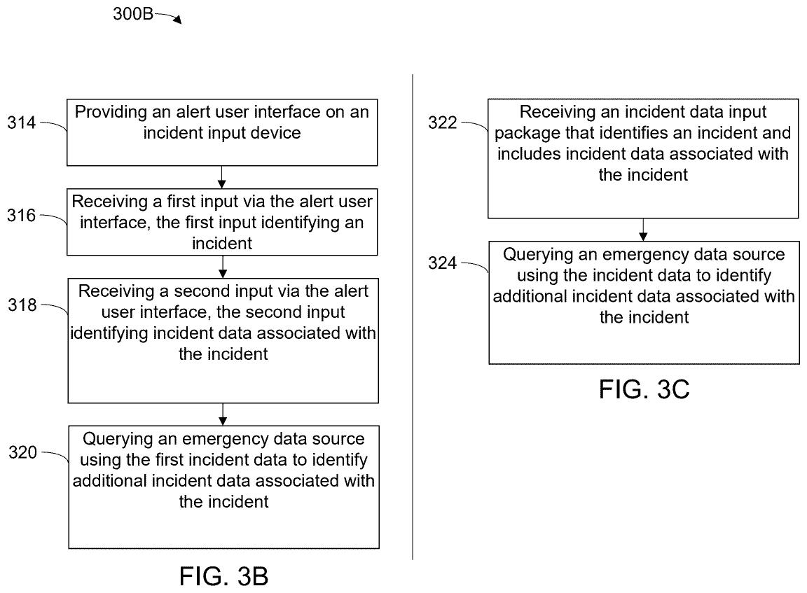

FIG. 3A shows another illustrative embodiment of a method 300A for an emergency response protocol for sharing incident data with field responders. At step 302, the EMS 102 receives notification criteria associated with field responders. The notification criteria may be the same as discussed above, including, for example, coverage or jurisdictional boundaries of the field responders and timing of transmission of data to field responders. At step 304, the EMS 102 identifies an incident based on input from an incident input device, such as those described above. In some non-limiting examples, the identification of an incident occurs based on a phone call or message (e.g., a 9-1-1 call or text message), device or sensor activation based on a trigger, or a monitoring application such as an infrastructure portal for monitoring railways. At step 306, the EMS 102 determines incident data associated with the incident. For instance, the EMS 102 may consolidate and/or filter data received that is associated with the incident to create an alert or “pre-alert” package of information to be electronically transmitted to and accessed via the ECC data interface 122, via the emergency responder data interface 124, or via field responder devices 114 (see FIG. 1). This information may include, for instance, one or more of incident type, location, date/time, HazMat information, weapons information, and other incident specific information. In some approaches, some or all of the information is specifically provided or input by a human present at or involved in the emergency and/or provided through sensors or other contextual data feeds or databases (e.g., camera data, emergency call data, medical/health data, law enforcement data, weather data, demographic data, multimedia or news data (e.g., from news feeds), social media feeds). In some approaches, some of the information may be determined through algorithms trained on historical incident data.

At step 308, the EMS 102 determines, based on the notification criteria, target field responder providers, groups of field responders, and/or individual field responders to receive the incident data. For instance, in some approaches the target field responders are selected based on one or more of location of the incident, type of incident, location of the field responders, and/or specific hazardous details of the incident (e.g., weapons detected). Field responders may also be selected based on whether they are eligible to receive pre-alert data prior to dispatch.

At step 310, the EMS transmits the incident data to the target field responders, which, in different examples, may occur prior to an official dispatch, concurrently therewith, or after. Different ways the incident data may be transmitted to the target field responders are shown and described with reference to FIGS. 4-6. At step 312, the EMS receives transmit confirmation data, which may include, for example, a count of the field responder devices that received the transmission of incident data, a timestamp of transmission, and/or a timestamp of when the incident data was accessed or each time the incident data was accessed.

FIG. 3B shows an illustrative embodiment of a method 300B of identifying an incident and incident data via an emergency management system, such as EMS 102. At step 314, an alert user interface is provided on an incident input device. For instance, as discussed above with respect to FIG. 1, an alert user interface on an incident input device may be in the form of an application or mobile application. In some embodiments, the alert user interface may be an application portal associated with or accessed by an operations center or monitoring station such as a rail network operation center (NOC) that is used to input incident data. At step 316, the EMS receives a first input via the alert user interface, the first input identifying an incident. At step 318, the EMS receives a second input via the alert user interface, the second input identifying incident data associated with the incident. At step 320, the EMS queries an emergency data source (such as emergency data sources 110 described above) using the known incident data to identify additional data associated with the incident.

In one non-limiting example, the alert user interface is a centralized monitoring application for an infrastructure. For instance, the application may be a centralized portal for monitoring current conditions of railways, for instance, associated with or access by a rail NOC. According to method 300B, a first input identifying a rail incident (such as a derailment) may be received via the application, and a second input identifying additional incident data may further be received via the application. For instance, follow-up information may include an incident type, an incident location, a train identifier, a train car affected, etc. The EMS may then query data sources (such as an infrastructure information database) using the known incident data to identify additional data. For instance, in a railway emergency situation, a train identifier may be used to query an infrastructure information database to obtain “consist” data which includes information regarding each railcar of the train and the cargo of each of the railcars. In some cases, the train consist will indicate that one or more of the railcars contains hazardous material. If there is an indication of hazardous material in the consist, the EMS may then proceed to query an emergency response guidebook (ERG) database to obtain relevant ERG protocol information to include as part of the alert.

FIG. 3C shows another illustrative embodiment of a method 300C of identifying an incident and incident data via an emergency management system, such as EMS 102. At step 322, the method includes receiving an incident data input package that identifies an incident and includes incident data associated with the incident. The incident data may include, for instance, incident location, incident type, and any other specific details about the incident. In some embodiments, the incident data is provided by the incident input devices 108 described above. At step 324, the method includes querying an emergency data source (such as emergency data sources 110 described above) using the known incident data to identify additional incident data associated with the incident.

For instance, in one non-limiting example, the EMS may receive an incident data input package from a third party ride-share mobile application on a mobile device. In some approaches, the ride-share application includes an alert button on a graphical user interface that permits a user (such as a driver or a rider) to submit information about an incident to the EMS. The incident data input package may include the location of the incident, the type of incident, the name of the user, other input details about the incident, etc. If the reported incident is a rail derailment, for example, the incident data provided in the package may then be used to query an emergency data source for additional incident data associated with the incident. For instance, the EMS may use the reported location to query map databases or camera/video feed databases for additional contextual information.

FIGS. 4-6 show illustrative methods for emergency response protocols for transmitting incident data to field responders. FIG. 4, in particular, shows a method 400 in which the alert or pre-alert incident data is transmitted to an emergency responder system, such as emergency responder system 104, and to field responder devices. At steps 402 and 404, respectively, the EMS identifies an incident and automatically transmits incident data to an emergency responder system. In some approaches, the emergency responder system includes a server-based web application that includes the emergency responder data interface 124 (see FIG. 1) or may be separate from and communicative with the emergency responder data interface 124. The emergency responder system may be associated with a specific emergency responder provider.

At step 406, the emergency responder system electronically transmits the incident data to target field responders. In exemplary embodiments, this transmission of incident data to target field responders occurs automatically, and the selection of the field responders may occur as described above.

At step 408, the transmission of incident data to target field responders may be sent in different ways. For instance, the incident data may be sent to the emergency responder data interface 124 and specifically to different field responder accounts associated with the emergency responder data interface 124. In this case, for example, the emergency responder data interface 124 may be an application or portal executed on the field responder devices 114. The field responders can log in to the application or portal on their accounts to view the incident data on a graphical user interface.

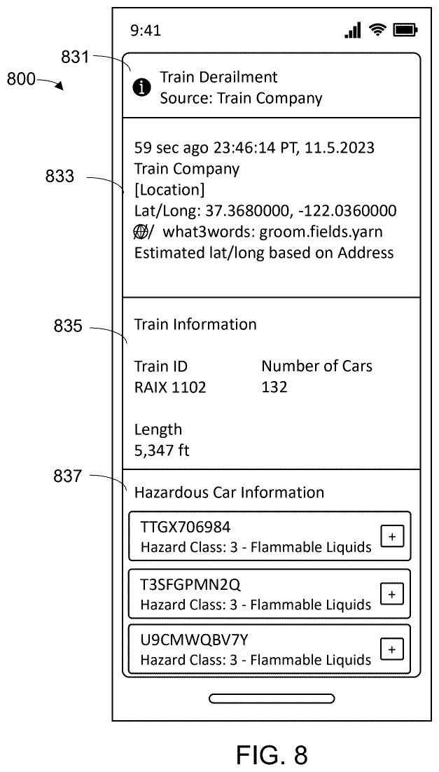

In some approaches, the field responders may receive a push notification indicating the incident data has been received. In embodiments, the application is in communication with the EMS via an API. In other approaches, the emergency responder system may additionally or alternatively transmit the incident data to one or more field responders as a hyperlink via SMS (text or data) or email. The hyperlink may link to a webpage that contains the incident data, such as the webpage shown in FIG. 8. In some approaches, the SMS may be sent via a 5-digit short code, or by a 10 digit number. In method 400, the data flow between the EMS and the field responders may altogether bypass an emergency communications center so that field responders rapidly receive information without waiting for dispatch or for information to be forwarded from the emergency communications center.

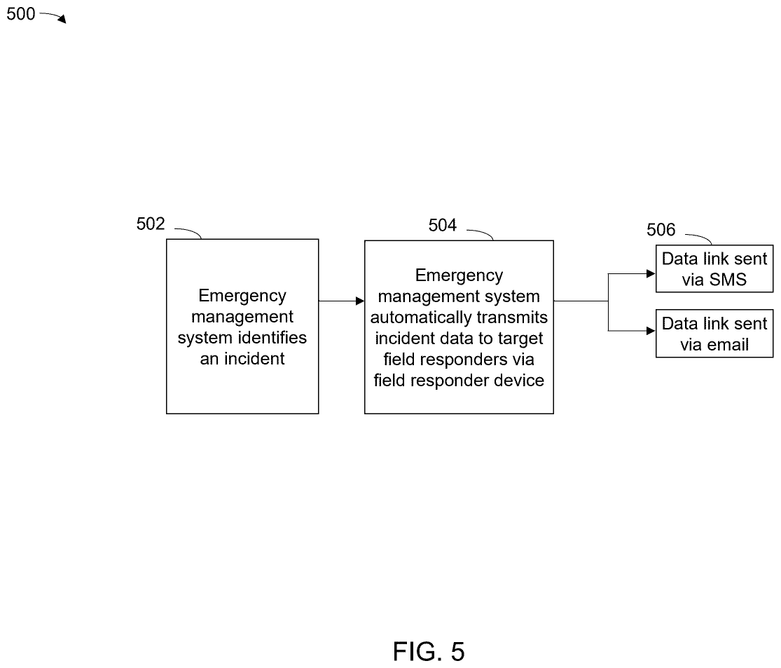

FIG. 5 shows a method 500 in which the alert or pre-alert incident data is automatically transmitted from the EMS to specific field responder devices without being routed through the emergency responder system like in method 400. At steps 502 and 504, respectively, the EMS identifies an incident and automatically transmits incident data to target field responder devices. The selection of the field responders may occur as described above. In illustrative embodiments, this transmission to field responders occurs almost immediately after the EMS identifies the incident.

At step 506, the transmission may occur, in some approaches, through a hyperlink sent via SMS (text or data) or email). In some approaches, the SMS may be sent via a 5-digit short code, or by a 10 digit number. The hyperlink may link to a webpage that contains the incident data, such as the webpage shown in FIG. 8. In other embodiments, the EMS may communicate with a field responder application such as the emergency responder data interface 124 so that the incident data can be transmitted to target field responder accounts associated with the application and viewable on a graphical user interface of the application. In method 500, the data flow between the EMS and the field responders may altogether bypass an emergency communications center system and an emergency responder system so that field responders rapidly receive information without waiting for dispatch or for information to be forwarded from the emergency communications center or the emergency responder system.

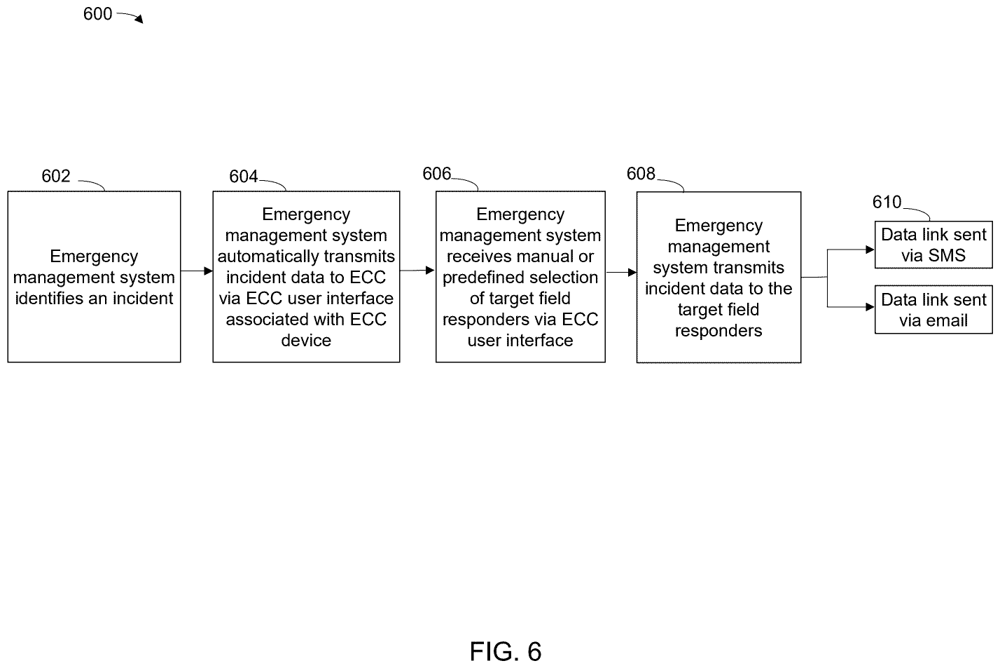

FIG. 6 shows a method 600 in which the alert or pre-alert incident data is transmitted to target field responders after target field responders are selected via an ECC user interface (such as ECC user interface 154 executing ECC data interface 122 of the EMS). At step 602, the EMS identifies an incident. At step 604, the EMS automatically transmits alert or pre-alert incident data to an ECC system via the ECC user interface associated with an ECC device. At step 606, the EMS receives a manually input or predefined selection of target field responders via the ECC user interface. At step 608, the EMS transmits the incident data to the selected target field responders. At step 506, the transmission may occur, in some approaches, through a hyperlink sent via SMS (text or data) or email).

In other embodiments, the EMS may communicate with a field responder application such as the emergency responder data interface 124 so that the incident data can be transmitted to target field responder accounts associated with the application and viewable on a graphical user interface of the application. In method 600, the selection of target field responders via the ECC user interface and the transmission of the data to the field responders may occur prior to an official dispatch of the field responders, thus constituting a “pre-alert.” In other embodiments, the selection and transmission may occur concurrently with dispatching the field responders or after a dispatch order is transmitted to the field responders via the emergency communications center.

FIG. 7 is an exemplary graphical user interface 700 that may be a part of the ECC user interface 154, the ECC data interface 122, the emergency responder data interface, or other interfaces or applications associated with an emergency responder system, emergency responder provider, or field responder devices. In some approaches, the graphical user interface 700 allows an ECC operator or emergency responder agent to add specific field responders to a notification list 741. In the illustrated embodiment, the list enables SMS text notifications containing incident data to be sent to the listed field responders when an incident occurs. The list includes information about each field responder such as name, department, position, title, email address, and cellphone number, and includes an option to individually delete field responders from the list. New responders (e.g., responder name, title, phone number, email address, etc.) can be manually added to the list via an “Add New Responder” button 743 or existing field responders may be searched for via a search dialogue box 745 to add to the list.

The graphical user interface 700 may also include an option to add a group or type of responders to notify via SMS. In some approaches, there is a responder type option 747 to define and/or select specific groups of responders based on the type of incident. For instance, there may be groups of responders selected from police, fire, coast guard, emergency medical services, highway police, etc.

In some approaches, the graphical user interface 700 may be accessed by the ECC to select responders or groups of responders to notify after a specific alert is received. In some approaches, the graphical user interface 700 is accessed by an ECC to pre-populate lists of field responders to receive notifications, which may be sent to the EMS 102. In various approaches, the emergency responder system may access the graphical user interface 700 to generate the lists of field responders to send to an ECC or to the EMS 102.

FIG. 8 is an exemplary notification screen or page 800 displayed on a field responder device. In some approaches, the notification screen 800 may be a part of the webpage that is presented via a user interface when a field responder clicks on the hyperlink transmitted by SMS or email, for example, by the EMS, an ECC, or an emergency responder system according to methods 400, 500, and 600 described above.

In some embodiments, the notification screen 800 may be a notification associated with a field responder application such as the emergency responder data interface 124. In some approaches, the notification screen 800 displays pre-alert incident data that is viewable by the field responders prior to receiving a formal dispatch, and, in some examples, very shortly after the incident occurs. However, the notification screen 800 may also be accessible as part of a dispatch request or after a dispatch request in accordance with various embodiments.

The notification screen 800 may display information such as the type of incident 831, the location of the incident 833, and other incident-specific information 835 or hazardous information 837. The notification screen 800 may also display the source of the alert, and a date and time of the incident. In some approaches, the notification screen 800 is dynamic and is updated when new information is received. In these approaches, the notification screen 800 may include timestamps regarding the last updates made to the notification screen 800. In some approaches, the notification screen 800 includes a link to an additional website page with further information such as a map or a link to a portal (e.g., the field responder application such as the emergency responder data interface 124) containing additional information. In some approaches, the notification screen 800 contains a link to an emergency response guidebook (ERG) protocol relevant to the alert.

In the illustrated example of a train derailment incident, the incident-specific information 835 includes information about the train, such as a train identifier, the number of cars of the train, a length of the train, etc. The hazardous information 837 may include a list of cars containing hazardous materials, the class of the hazardous materials, and/or the type of hazardous materials.

In some approaches, the notification includes a link to an additional website page with further information such as a map, or a link to a portal (e.g., the field responder application such as the emergency responder data interface 124) containing additional information.

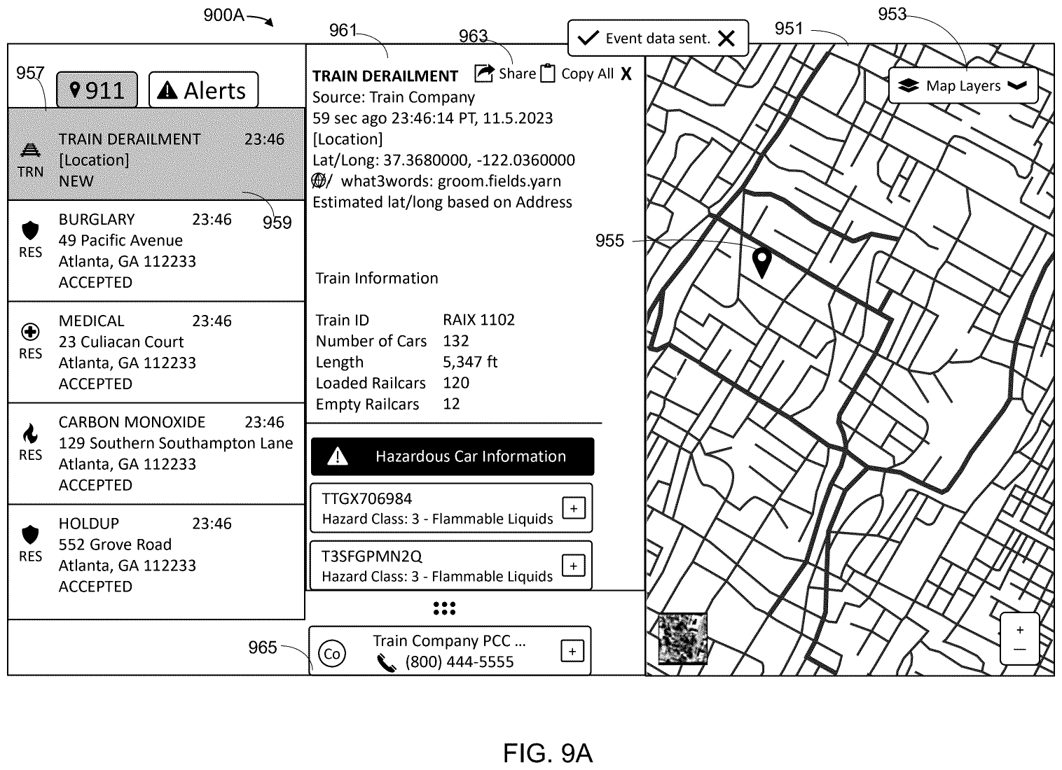

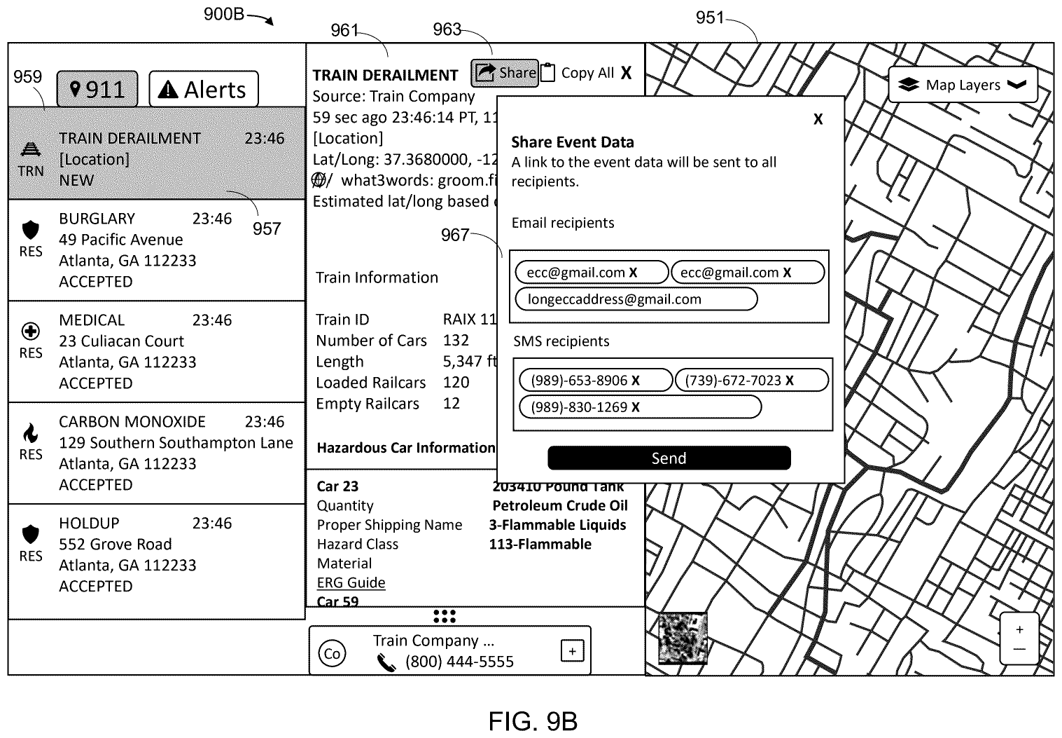

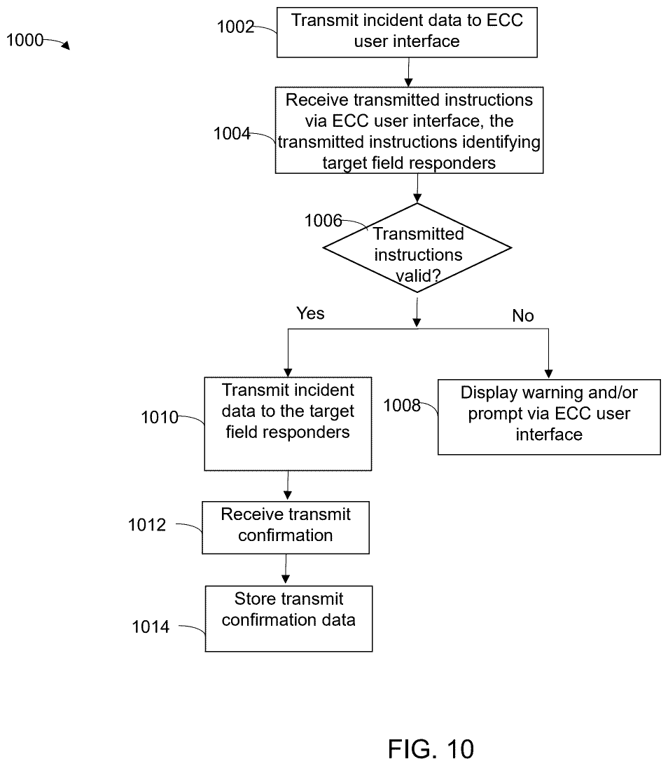

FIGS. 9A and 9B show exemplary ECC user interfaces that permit ECC users to see and monitor incident data associated with an incident or alert and to perform other non-limiting functions such as sharing incident data and dispatching emergency responders. The ECC user interfaces, in some approaches, may be graphical user interfaces of the ECC data interface 122 of the EMS 102 that are executed on a computing device of the ECC system 112 (see FIG. 1).

FIG. 9A shows an ECC user interface 900A that includes an interactive map view 951 that may show at least one location of an incident. In some embodiments, the map view 951 may show an area of jurisdiction or coverage area of the ECC and multiple concurrent incidents. The map view 951 may include various layers that may be turned on and off using map layers control 953. The map view 951 may also have a satellite view control that may be turned on and off, as well as other controls to zoom in and zoom out of the map 951. One or more location indicators 955 may be displayed that show incident locations and may provide other information such as emergency type, severity, whether the emergency is being handled, etc. and this information may be provided by text, fonts, colors, icon shape and size, flashing indications, etc. and any combination of these features, among other options.

An incident list or queue 957 is also provided with various queue entries for incidents that have been sent by the EMS, incoming emergency calls, or both. In some implementations, the operator may have selectable tabs to switch between an emergency call (e.g. 9-1-1 calls) queue and an emergency alerts queue. The queue entries are selectable and enable display of further detailed information. For example, illustrated queue entry 959 indicates a train derailment and may be selected to show a data card 961. The data card 961 may display incident data similar to the incident data shown in FIG. 8 and described above, such as the type of incident, the location of the incident, and other incident-specific information or hazardous material information. The source of the alert, and a date and time of the incident may also be displayed, as well as timestamps or other indicators regarding when the data was last updated. In some approaches, the data card 961 contains a link to access an emergency response guidebook (ERG) protocol.

In the illustrated example of a train derailment incident, there may be incident-specific information about the train, such as a train identifier, the number of cars of the train, a length of the train, etc. There also may be hazardous information that may include a list of cars containing hazardous materials, the class of the hazardous materials, and/or the type of hazardous materials. The data card 961 may include a selectable option 965 to call and/or message the person or entity reporting the alert. A share button 963 may also be present in the data card 961 to share incident data with field responder providers and/or specific field responders.

At least some of the queue entries may show one or more icons that indicate the type of incident related to the entry. For example, queue entry 959, which is for a train derailment, shows a train track icon. The icons may be of any size or shape, may utilize various colors and may be flashing. The queue entries also indicate if the entry has been accepted by an ECC operator or agent, or whether the entry is new and needs to be accepted and handled.

FIG. 9B illustrates an ECC user interface 900B similar to ECC user interface 900A, with a map 951 indicating a location of the incident, the incident queue 957, the incident data card 961 for the selected incident, and a “share” card or popup window 967 that is displayed when an ECC operator selects the “share” button 963. The “share” card may include one or more data entry fields through which a user can select or enter field responders with whom the incident data is to be shared (for example, as a “pre-alert” prior to dispatch).

For instance, in the illustrated embodiment, data entry fields are provided for entering email recipients and/or SMS recipients of the incident data. In some approaches, email addresses, phone numbers, or names electronically associated with email addresses or phone numbers may be manually entered for the targeted field responders.

In some embodiments, there may be an option to select a predefined group of field responders, and the group, in some embodiments, may be editable. In some approaches, the list of recipients is already pre-populated, displaying a predefined list of responders. For instance, the list of recipients may have been automatically determined by the EMS based on information about the current incident or may have been manually predetermined. There may additionally be a message field (not shown) that may be pre-populated with an editable entry related to the selected incident.

Upon submission of the form, a hyperlink to a webpage generated by the EMS containing the incident data may be transmitted to the selected field responders via SMS or email (as described above with respect to FIG. 6). In other approaches, sharing the data causes the incident data to appear in a graphical user interface of a field responder application. In these manners, a pre-alert message may be sent to field responder devices with information to make the field responders aware of the situation even before a dispatch call or order is made to the field responders.

FIG. 10 illustrates an exemplary method 1000 for emergency response protocol for transmitting incident data to field responders, in accordance with some embodiments. In some approaches, the steps of method 1000 are performed by the EMS (e.g., EMS 102). At step 1002, the method 1000 includes transmitting incident data to the ECC user interface, which may, as discussed above, be a separate ECC user interface on an ECC computing device in communication with the EMS 102 or may comprise an instance of the ECC data interface 122 of the EMS 102 (e.g., a web application) executed on an ECC computing device (see FIG. 1). At step 1004, transmitted instructions may be received from or via the ECC user interface, the transmitted instructions identifying target field responders to receive incident data (e.g., as a pre-alert). In some approaches, this occurs after an ECC operator submits the target field responder information on the “share” card 967 on the ECC user interface 900B (see FIG. 9B).

At step 1006, the EMS confirms or verifies whether the transmitted instructions are valid. In some examples, this occurs via the notification/mobilization engine 118 of the EMS 102 (see FIG. 1). For instance, the phone numbers, email addresses, and field responder names, account names, and/or other identifiers may be checked for proper format, verified against information in databases, or checked for consistency with notification criteria.

At step 1008, if the EMS determines the instructions are not valid, a warning and/or prompt may be displayed on the ECC user interface so that the ECC operator is aware the instructions are invalid and incident data has not been shared, and to provide the ECC operator a prompt to fix the incorrect instructions. At step 1010, if the EMS determines the instructions are valid, the incident data is transmitted to the target field responders, for example, via SMS, email, or to a field responder application on each of the field responder devices. At step 1012, the EMS receives confirmation that the incident data was successfully transmitted to the field responder devices in the selected mode.

In some approaches, for example, a hyperlink to a webpage is sent via SMS or email to a field responder device and the EMS receives confirmation whenever the webpage is accessed by the field responder. In other approaches, when the incident data is transmitted to a field responder's account of a field responder application, the EMS receives confirmation whenever the field responder views the incident data in the application. At step 1014, the EMS may store transmit confirmation data such as the field responder identification, phone number, email address, and the time of access and/or number of times the incident data was accessed by the field responder.

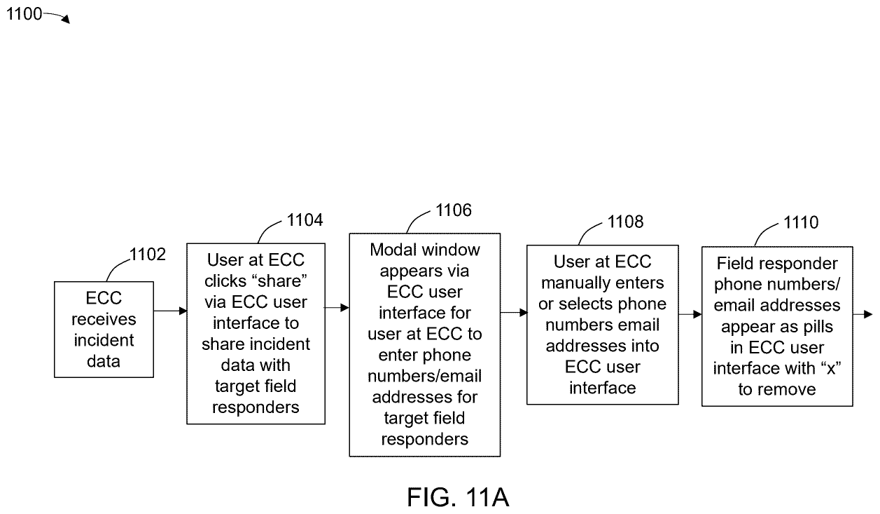

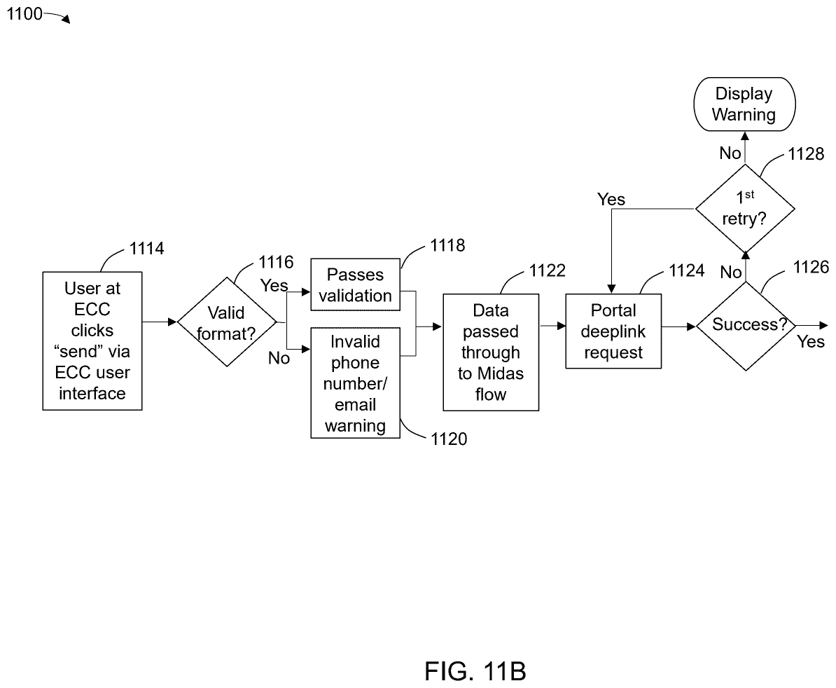

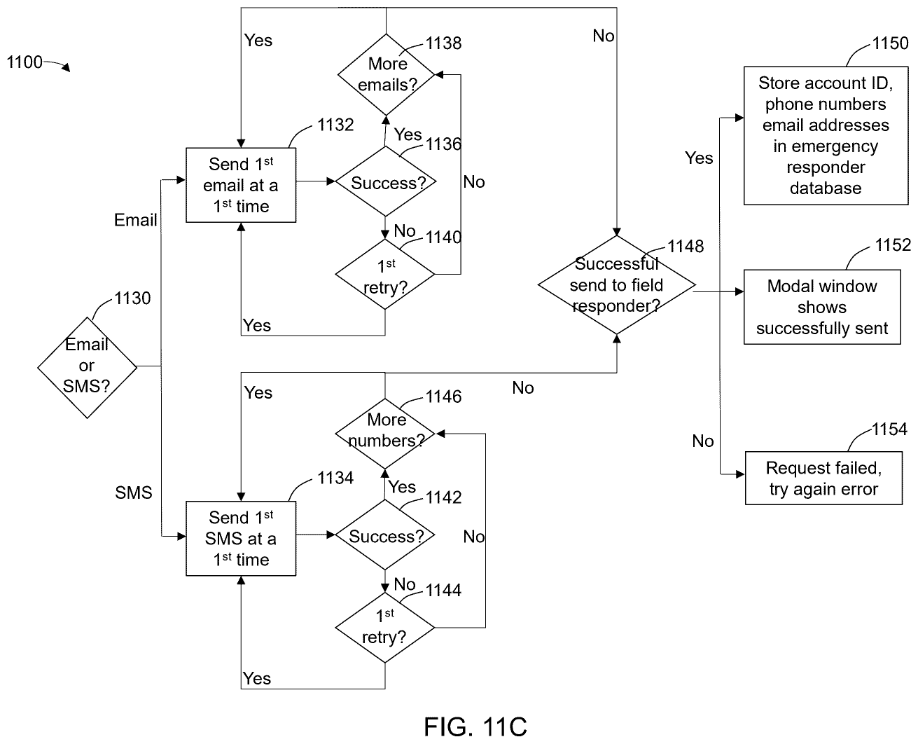

FIGS. 11A, 11B, and 11C illustrate portions of a method for an emergency response protocol for transmitting incident data to field responders, in accordance with some embodiments. The method 1100 includes, at steps 1102 and 1104, respectively, the ECC user interface receiving incident data and clicking a “share” button via the ECC user interface to share incident with target field responders. In some approaches, the shared data is pre-alert data that is shared with the field responders prior to the field responders receiving dispatch orders.

At step 1106 a window or dialogue box is displayed on the ECC user interface with data entry fields for an ECC operator to manually select or enter phone numbers, email addresses, and/or names or other identifiers of target field responders associated with phone numbers, email addresses, or application accounts to receive the incident data. At step 1108, the ECC operator manually enters the phone numbers, email addresses, and/or names or other identifiers of target field responders associated with phone numbers, email addresses, or application accounts. At step 1110, each of the field responder phone numbers, email addresses, and/or names or other identifiers of target field responders associated with phone numbers, email addresses, or application accounts may appear as pills in the ECC user interface aside an “x” to remove the entry. At step 1114, the ECC operator typically clicks a button on the user interface to send the incident data to the target field responders.

At step 1116, the EMS and/or ECC user interface may confirm whether the field responder entries are in a valid format. At step 1120, if an entry is not in a valid format, the ECC user interface may display a warning or prompt indicating, for example, that an entered phone number or email address is invalid. At step 1118, if the entries are valid, the submission passes validation and a data payload comprising the an alert or incident identifier, and a list of phone numbers, email addresses, and/or field responder accounts is passed through to a back-end processing flow of the EMS at step 1122. At step 1124, a portal deeplink is requested to create a webpage and hyperlink address for the webpage containing the incident data. The portal deeplink may be a pre-configured authentication or authentication session or token. At step 1126, the EMS verifies that the portal deeplink was successfully created. At step 1128, if the portal deeplink was not successfully created there may be one or more retry attempts, or a warning may be displayed. If the portal deeplink was successfully created, at step 1130 the EMS determines whether to send the deeplink via email or SMS for each field responder. For each field responder email address, at steps 1132, 1136, and 1138, the EMS sends each email one at a time. After validating the successful transmission of each email, the EMS checks whether there are additional email addresses and sends the remaining emails one at a time. If an email transmission is not successful, in some cases there may be one or more retry attempts.

For each field responder phone number, at steps 1134, 1142, and 1146, the EMS sends each SMS message one at a time. After validating the successful transmission of each SMS message, the EMS checks whether there are additional phone numbers and sends the remaining SMS messages one at a time. If an SMS message transmission is not successful, in some cases there may be one or more retry attempts.

At step 1148, the EMS may determine or confirm that all of the transmissions (email and/or phone number) were successfully sent to the targeted field responders. At step 1154, if the transmissions were not all successful, the ECC user interface may display a window or other indication that the send request failed, so that the ECC operator can make edits and attempt the submission again. If all of the transmissions were successfully sent, a window on the ECC user interface, at step 1152, may indicate that the incident data was successful sent. In addition, in some approaches, the phone numbers, email addresses, account identifiers, names, and/or other identifiers of the field responders may be stored, for example, in an emergency responder database (such as emergency responder database 106 shown in FIG. 1), which may be communicatively linked with the EMS via, for example, an API.

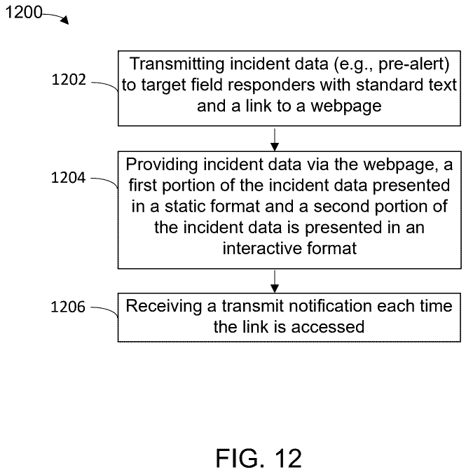

FIG. 12 illustrates an exemplary method 1200 for transmitting incident data via a webpage to field responders, in accordance with some embodiments. At step 1202, the method 1200 includes transmitting incident data (e.g., pre-alert incident data) to target field responders with standard text and a hyperlink to a webpage. In some approaches, the EMS transmits the text and hyperlink to specific field responders via an SMS text message or via an email message. In some approaches, other HTTP messaging systems may be used. In various embodiments, the specific field responders may be selected and the transmission may occur in any of the manners discussed above. In some approaches, the text message or email message contains simplified text information about the incident (e.g., a type, location, date/time of the incident) and the link to the webpage is provided to access additional information or to monitor incident information as it is updated.

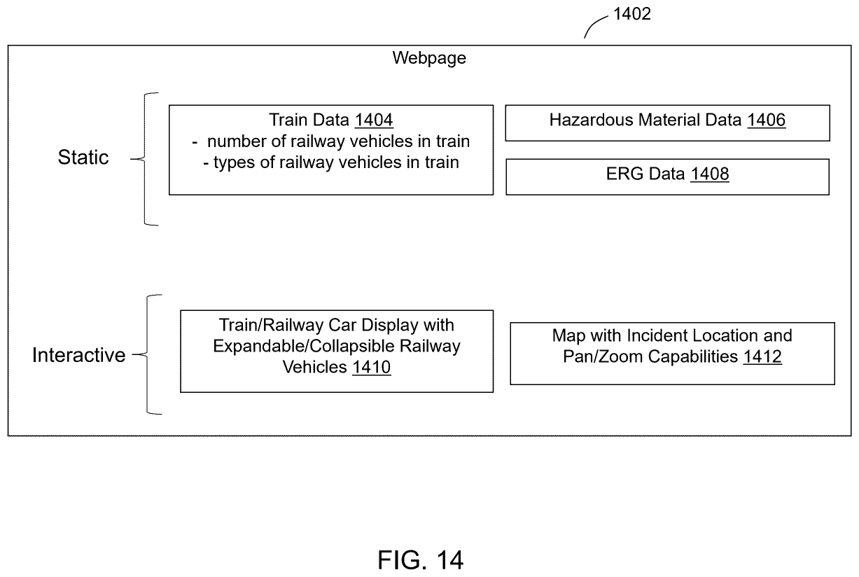

At step 1204, incident data is provided via the webpage, with a first portion of the incident data being presented in a static or non-interactive format and a second portion of the incident data being presented in an interactive format. For instance, an exemplary diagram of a webpage 1402, shown in FIG. 14, includes several static portions (e.g., 1404, 1406, 1408) that may be scrollable and simply list specific incident data, as well as several interactive portions that allow the user to control or change how the data is presented. For instance, in the illustrated example for a railway incident, a static portion 1404 may include train data (such as Consist data), including a number and types of railway vehicles in the train. Other static portions may include, for instance, hazardous material data 1406 and ERG data 1408 (including an ERG protocol to follow or a link to the protocol). An interactive portion 1410 may include an expandable/collapsible train/railway car display, so that the user can select different portions of the train or cars to view relevant information and for ease of display. Another interactive portion 1412 may include a map with incident location and pan/zoom capabilities. Other interactive portions may be included, such as, for example, a chat or messaging window or dialogue box. At step 1206, the method 1200 includes receiving a transmit notification each time the webpage link is accessed. For instance, the EMS may receive the transmit notification and store data related to how many times the webpage link is accessed, who accessed the link, and timestamps of access. In some approaches, an emergency provider system and/or an emergency communications center system receives or is provided access to this information and can display the information to an operator.

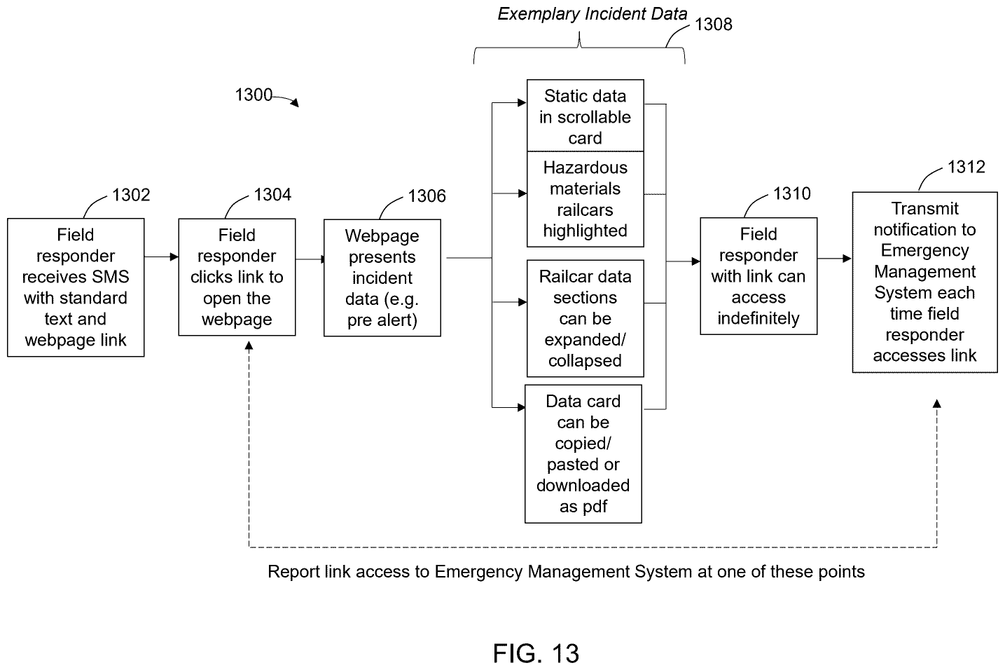

FIG. 13 illustrates an exemplary method 1300 for accessing incident data via a webpage and reporting link access, in accordance with some embodiments. At step 1302, the method 1300 may include one or more selected field responders receiving an SMS message for an incident containing standard text and a webpage hyperlink. Alternatively, the message may be an email message or use another type of messaging system (e.g., an HTTP type messaging system). In some approaches, the message contains simplified text information about the incident (e.g., a type, location, date/time of the incident) and the link to the webpage is provided to access additional information or to monitor incident information as it is updated.

At steps 1304 and 1306, respectively, the field responder clicks the link to open the webpage and the webpage displays incident data (e.g., pre-alert incident data). As a non-limiting example, and as shown in FIG. 14, the incident data 1308 may pertain to a railway incident and may include, for example, static data in a scrollable card, a list of any hazardous materials in railcars, railcar data sections that can be expanded or collapsed to view information for different railcars, and a data card section containing essential data that can be copied and pasted or downloaded as a pdf.

At step 1310, the field responder may re-visit the webpage as necessary, for instance, to review data or view any updates. In some approaches, the link can be accessed indefinitely (e.g., during resolution of the incident and beyond). In some cases, the link may expire after an incident is resolved or after a certain period of time after the incident is resolved (e.g., a day, a week, a month, a year). At step 1312, the method 1300 includes transmitting a notification to the EMS each time a field responder accesses the link or webpage. In some approaches, for instance, link access is reported to the EMS each initial time a field responder clicks the link to access the webpage and each additional time the field responder clicks the link to access the webpage. In some approaches, an emergency provider system and/or an emergency communications center system receives or is provided access to this information and can display the information to an operator.

While many of the incident examples described herein pertain to a train derailment, it is to be understood that the incident type is non-limiting and that high level steps of the methods described herein may be used for other types of incidents, such as active assailant incidents or otherwise. It should also be understood that any of the methods and processes described herein may be executed using one or more components of the emergency management provider system 100 shown and described with reference to FIG. 1.

In some aspects, a method for implementing an emergency response protocol includes receiving notification criteria for a field response provider. The method also includes receiving incident data on an incident. The method also includes determining, based on the notification criteria and the incident data, at least one target field responder to receive the incident data. The method further includes transmitting the incident data to a user interface associated with an emergency communication center and also transmitting the incident data to the at least one target field responder.

In some aspects, a method for emergency response protocol may include receiving geographic or jurisdictional boundary data for a field response provider via a first user interface associated with the field response provider. The geographic boundary data defines a coverage area for the field response provider. The method also includes receiving incident data on an incident. The incident data may include an incident location. The method also includes transmitting the incident data to a second user interface associated with an emergency communication center. The method further includes determining, based on the location, whether the incident is within the coverage area for the emergency service provider. Upon determining that the incident is within the coverage area for the first response provider, the method includes automatically transmitting the incident data to the field response provider. In some approaches, the incident data is transmitted to the field response provider before the emergency communication center dispatches the field response provider to the incident.

In some aspects, an emergency management provider system includes a responder notification system (RNS). The RNS may comprise a memory, a network component, and at least one processor. The RNS is communicatively coupled to an emergency data source. The at least one processor is configured to receive an emergency alert comprising a device identifier associated with an electronic device and a location of an emergency. The at least one processor is also configured to determine, using the location of the emergency, an appropriate emergency service provider for responding to the emergency. The at least one processor is also configured to retrieve a list of contact information associated with a plurality of responders associated with the ESP, wherein the ESP has authorized sharing of the emergency alert with the plurality of responders. The at least one processor is further configured to transmit to a plurality of responder devices associated with the plurality of responders, a notification message comprising the emergency location.

The methods, techniques, systems, devices, services, servers, sources and the like described herein may be utilized, implemented and/or run on many different types of devices and/or systems. Referring to FIG. 16, there is illustrated a system 1600 that may be used for any such implementations, in accordance with some embodiments. One or more components of the system 1600 may be used to implement any system, apparatus or device mentioned above, or parts of such systems, apparatuses or devices, such as for example any of the above or below mentioned control circuits, electronic user devices, sensor(s), databases, parts thereof, and the like. However, the use of the system 1600 or any portion thereof is certainly not required.

By way of example, the system 1600 may include one or more control circuits 1602, memory 1604, input/output (I/O) interface 1606, and/or user interface 1608. The control circuit 1602 typically comprises one or more processors and/or microprocessors. The memory 1604 stores the operational code or set of instructions that is executed by the control circuit 1602 and/or processor to implement the functionality of the systems and devices described herein, parts thereof, and the like. In some embodiments, the memory 1604 may also store some or all of particular data that may be needed to assist with providing incident data to first responders or to other entities as described herein

It is understood that the control circuit 1602 and/or processor may be implemented as one or more processor devices as are well known in the art. Similarly, the memory 1604 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 1604 is shown as internal to the system 1600; however, the memory 1604 can be internal, external or a combination of internal and external memory. The system 1600 also may include a database (not shown in FIG. 16) as internal, external, or a combination of internal and external to the system 1600. Additionally, the system typically includes a power supply (not shown), which may be rechargeable, and/or it may receive power from an external source. While FIG. 16 illustrates the various components being coupled together via a bus, it is understood that the various components may actually be coupled to the system 100 of FIG. 1 and/or one or more components thereof directly.

Generally, the control circuit 1602 and/or electronic components of the system 1600 can comprise fixed-purpose hard-wired platforms or can comprise a partially or wholly programmable platform. These architectural options are well known and understood in the art and require no further description here. The system and/or control circuit 1602 can be configured (for example, by using corresponding programming as will be well understood by those skilled in the art) to carry out one or more of the steps, actions, and/or functions described herein. In some implementations, the control circuit 1602 and the memory 1604 may be integrated together, such as in a microcontroller, application specification integrated circuit, field programmable gate array or other such device, or may be separate devices coupled together.

The I/O interface 1606 allows wired and/or wireless communication coupling of the system 1600 to external components and/or or systems. Typically, the I/O interface 1606 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 1610 may be used for user input and/or output display. For example, the user interface 1610 may include any known input devices, such one or more buttons, knobs, selectors, switches, keys, touch input surfaces, audio input, and/or displays, etc. Additionally, the user interface 1610 include one or more output display devices, such as lights, visual indicators, display screens, etc. to convey information to a user, such as but not limited to communication information, instructions regarding unloading of the delivery vehicle, status information, order information, delivery information, notifications, errors, conditions, and/or other such information. Similarly, the user interface 1610 in some embodiments may include audio systems that can receive audio commands or requests verbally issued by a user, and/or output audio content, alerts and the like.

Those skilled in the art will recognize and appreciate that such a processor can comprise a fixed-purpose hard-wired platform or can comprise a partially or wholly programmable platform. All of these architectural options are well known and understood in the art and require no further description here.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A method for providing incident data to one or more field responders, the method comprising:
receiving notification criteria associated with a field response provider;
receiving incident data regarding an incident;
determining, based on the notification criteria and the incident data, at least one target field responder associated with the field response provider to receive the incident data;
transmitting the incident data to a graphical user interface executed on a computing device associated with an emergency communication center (ECC), wherein the ECC controls dispatch of field responders to incidents; and
transmitting the incident data to the at least one target field responder prior to the at least one target field responder being dispatched to the incident by the ECC.

2. The method of claim 1, wherein the notification criteria is a geographic boundary.

3. The method of claim 1, wherein the incident data is transmitted to the at least one target field responder substantially concurrently with the incident data being transmitted to the graphical user interface executed on the computing device associated with the ECC.

4. The method of claim 1, further including:
receiving a count of the at least one target field responder that received the incident data and an associated timestamp.

5. The method of claim 1, wherein transmitting the incident data to the at least one target field responder includes transmitting the incident data via at least one of an email or short message service (SMS) message.

6. The method of claim 5, further including generating a webpage containing the incident data and a hyperlink to the webpage, and including the hyperlink in the at least one of email or SMS message.

7. The method of claim 1, wherein transmitting the incident data to the at least one target field responder includes transmitting the incident data to a web or mobile application accessible by the at least one target field responder.

8. An emergency management system (EMS) comprising at least one memory including computer program code, a network component, and at least one processor, wherein the EMS is communicatively coupled to an emergency data source and wherein the at least one memory and the computer program code, with the at least one processor, are configured to cause the EMS to:
receive an emergency alert comprising a location of an emergency;
determine, using the location of the emergency, an emergency communication center (ECC) for responding to the emergency, wherein the ECC controls dispatch of field responders to incidents within a jurisdictional boundary;
receive a list of contact information associated with a plurality of responders associated with an emergency service provider (ESP), wherein the ESP has authorized sharing of the emergency alert with the plurality of responders; and
transmit to a plurality of responder devices associated with the plurality of responders, a notification message comprising the location of the emergency.

9. The system of claim 8, wherein the notification message is transmitted to the plurality of responder devices before the ESP receives an emergency dispatch order from the ECC to respond to the emergency.

10. The system of claim 8, wherein a query is transmitted to the emergency data source to retrieve additional emergency data associated with the emergency alert, and at least some of the additional emergency data is transmitted to the plurality of responder devices via the notification message.

11. The system of claim 8, wherein the emergency data retrieved from the emergency data source comprises hazmat information for train cars in a rail-related accident or weapon detection information for an active assailant incident.

12. The system of claim 8, wherein the emergency alert comprises a device identifier associated with an electronic device and the device identifier is associated with an emergency call or text-to-911 routed to the ECC.

13. The system of claim 8, wherein the notification message is an SMS message.

14. The system of claim 13, wherein the SMS message is sent using a 5-digit short code.

15. The system of claim 11, wherein the notification message is a push notification to the plurality of responder devices.

16. A method for executing an incident response management protocol comprising:
receiving, at a server computing device, incident information associated with an incident;
determining at least one set of field responders to receive the incident information, based on notification criteria associated with the field responders and the incident information;
transmitting, from the server computing device to user devices associated with the set of field responders, the incident information; and
transmitting, from the server computing device to an emergency communication center (ECC) server, the incident information concurrent with the transmission of information to the set of field responders.

17. The method of claim 16, wherein the transmission of the incident information to the user devices occurs prior the field responders receiving an emergency dispatch order to respond to the emergency, wherein the transmission of the incident information to the user devices occurs via a notification message containing a hyperlink to a webpage containing the incident information.

18. The method of claim 16, further comprising:
providing, from the server computing device, a graphical user interface (GUI) operable at the ECC, wherein the GUI includes an incident queue and a map; and
displaying a text box interface configured to receive contact information for the set of field responders, in response to selection of an incident share user interface element on the GUI at the ECC.

19. The method of claim 16, wherein the transmitting from the server computing device to the user devices associated with the set of field responders further includes transmitting information regarding recommended response actions including at least one of recommended response units, gear, and precautions.

20. The method of claim 19 wherein the recommended response actions are based on at least one of the following: type of event, location, weather, topography, climate, individuals impacted, and facilities involved.
